(19) United States
(12) Patent Application Publication
(10) Pub. No.: US 2025/0320060 A1
(43) Pub. Date: Oct. 16, 2025

(54) ITEM TRANSFER SYSTEM AND STORAGE AND RETRIEVAL SYSTEM

(71) Applicant: OCADO INNOVATION LIMITED, Hatfield, Hertfordshire (GB)

(72) Inventor: Leslie WYNN, Hatfield, Hertfordshire (GB)

(73) Assignee: OCADO INNOVATION LIMITED, Hatfield, Hertfordshire (GB)

(21) Appl. No.: 18/866,343

(22) PCT Filed: May 9, 2023
(86) PCT No.: PCT/EP2023/062278

§ 371 Date: Nov. 15, 2024

(30) Foreign Application Priority Data
May 16, 2022 (GB) 2207149.2

(51) Int. Cl. B65G 1/04; B65G 1/137; B65G 47/90

(52) U.S. Cl. CPC B65G 1/0464; B65G 1/1378; B65G 47/90; B65G 2201/0235

(57) ABSTRACT

An item transfer system includes a storage container with a U-shaped insert that is nested within the storage container. The item transfer system includes an item transfer station having a lifting device for vertically moving the insert out of the storage container to a raised position and an item moving device for horizontally moving an item onto and/or off the insert when the insert is in the raised position.

### TECHNICAL FIELD

The present invention relates to automated systems for transferring items into and out of storage containers and automated storage and retrieval systems.

### BACKGROUND

Some commercial and industrial activities require systems that enable the storage and retrieval of a large number of different products. WO2015/019055A1 describes a storage and retrieval system in which stacks of storage containers are arranged within a grid storage structure. The storage containers are accessed from above by load handling devices operative on rails or tracks located on the top of the grid storage structure.

Items to be stored within the storage and retrieval system are stored within the storage containers. An item may be a product that is stored directly in a storage container. An item may also be a sub-container designed to fit within a storage container. The sub-container may contain products for storage, or assembled orders to be delivered to customers.

Given the wide range of products that may be stored in the storage and retrieval system, automating the transfer of products into and out of storage containers is difficult and is typically carried out manually. Sub-containers are typically transferred into and out of storage containers by hand, or by machines specifically configured to handle a specific design of sub-containers and storage container.

In order to improve efficiency, it is desirable to provide a system for automating the transfer of items into and/or out of the storage containers. It is also desirable for the system to be able to handle loading and/or unloading of different types of items, including products and sub-containers.

### SUMMARY OF INVENTION

The invention is defined in the accompanying claims.

The invention provides an item transfer system. The item transfer system comprises a container unit. The container unit comprises: a storage container having a top opening; and an insert configured to nest within the storage container. The insert comprises an insert base and a pair of opposing insert sidewalls extending upwardly from the insert base to define an insert channel having a pair of end openings opposing each other in a horizontal direction for allowing items to enter and exit the insert channel in a horizontal direction. The item transfer system further comprises an item transfer station. The item transfer station comprises: a lifting device configured to vertically move the insert out of the storage container to a raised position at which the insert base is above the storage container and vertically move the insert back into the storage container from the raised position; and an item moving device configured to horizontally move an item onto and/or off the insert base via the end openings when the insert is in the raised position.

The container unit and the item transfer station of the present invention allows for an automated, flexible, multi-functional item transfer system in which one or more types of items can be transferred into and/or out of container units 50. Because items can be transferred into or out of the insert 57 by lifting the insert 57 and moving items in only a horizontal direction, there is no need to transfer items by picking them up, and therefore there is no need to take into account how different types of items (which may have different shapes, sizes, weights, compliabilities, fragilities etc.) need to be gripped and lifted in an automated system. There is therefore also no need to provide specialist equipment for picking each different type of item. The present invention therefore provides a system for transferring different types of items into and/or out of a storage container that is substantially agnostic to the type of item being transferred.

Furthermore, the use of an insert allows the item transfer system to be used with existing storage containers in existing storage systems, without the need to redesign the storage container. Furthermore, the use of an insert with upwardly extending sidewalls allows the insert to be engaged and lifted from above. An alternative system in which an insert is pushed upwards from below could require apertures to be formed in the base of the storage container, which would be undesirable as the storage container would not be able to contain leaks. The insert sidewalls also help to prevent items falling off the insert base when the insert is in the raised position.

The U-shape insert channel also allows access to, and sight of, the items within the container unit from above. This may be useful for systems where container units are used to store products and products are picked out of container units at picking stations to assemble customer orders. Picking is typically done using humans and is increasingly being automated using robotic arms. In both cases, access to and sight of the items from above (e.g. for machine vision systems) may be required.

The lifting device may be configured to engage the insert sidewalls to vertically move the insert into and out of the storage container. Each of the insert sidewalls may comprise a horizontally extending handle. The handles may horizontally extend in an outwards direction. The lifting device may be configured to engage the handles to vertically move the insert. The lifting device may comprise a pair of opposing lifting members configured to engage the handles to vertically move the insert. The handles may comprise engagement features (e.g. protrusions or recesses) that engage with corresponding engagement features of the lifting members when lifting the insert.

The handles of the insert may extend outwardly. The storage container may comprise a pair of opposing sidewalls, each sidewall comprising a cutout extending downwardly from a top surface (e.g. the rim) of the sidewall, the cutouts being configured such that each handle protrudes into a space defined by each cutout when the insert is nested in the storage container. In this way, the handles do not take up volumetric storage space within the storage container or within the insert channel, which allows the insert channel to be larger to hold more items or larger items.

The storage container may comprise container sidewalls. The insert sidewalls may be contiguous with the container sidewalls when the insert is nested within the storage container such that the insert sidewalls form part of the external sidewalls of the container unit. The container sidewalls may be configured to define two opposing side openings. For example, the storage container may comprise two taller opposing container sidewalls and two shorter opposing container sidewalls arranged in a rectangular shape to define the two opposing side openings. At least a portion, e.g. an upper portion, of each insert sidewall may be configured to occupy a respective side opening when the insert is nested within the storage container such that the insert sidewalls and the container sidewalls form a substantially contiguous structure.

The insert sidewalls may be configured to interlock the container sidewalls (e.g. the taller container sidewalls) in a vertical direction when the insert is nested within the storage container. For example, each insert sidewall may comprise a downwardly extending protrusion configured to be received in a corresponding recess or cutout in a container sidewall.

The insert may be open at the top, or at least comprise a top opening.

The insert base may be planar. The insert sidewalls may be planar. The underside of the insert base may comprise one or more ribs extending between the insert sidewalls to strengthen the insert base.

The insert base may be made from or coated in a material that provides a low-friction surface to allow items to slide relatively easily across the surface of the insert base. For example, the coefficient of friction of a particular item sliding on the low-friction surface of the insert base may be lower than the coefficient of friction of that same item sliding on the container base.

The item moving device may comprise one or more pushing members configured to move in a direction parallel to a longitudinal axis running through the end openings of the insert channel to horizontally push an item onto and/or off the insert base via one of the end openings. Each pushing member may be selectively movable in the direction parallel to the longitudinal axis of the insert channel using any suitable actuator, e.g. an electric, hydraulic, or pneumatic actuator. Each pushing member may be configured to move between an open position for allowing the pushing member to be positioned relative to the item, and a closed position for pushing the item. Each pushing member may be configured to pivotally rotate between the open position and the closed position, e.g. using any suitable rotary actuator.

The item moving device may comprises a first pushing member and a second pushing member spaced apart from the first pushing member in a direction parallel to the longitudinal axis of the insert channel. The first and second pushing members may be configured move in the direction parallel to the longitudinal axis of the insert channel to horizontally push a first item onto the insert base and horizontally push a second item off the insert base substantially simultaneously.

The item moving device may be a robotic arm, e.g. a Cartesian robotic arm or an articulated robotic arm. The robotic arm may be configured to horizontally push an item onto and/or off the insert base via one of the end openings.

The item transfer station may further comprise an alignment mechanism configured to centrally align an item about a longitudinal axis passing through the end openings of the insert channel. The alignment mechanism may comprise a pair of alignment members symmetrically located either side of the longitudinal axis, adjacent one of the end openings of the insert channel. The alignment members may be configured to move towards each other in a direction perpendicular to the longitudinal axis to centrally align an item located between them.

The item transfer station may further comprise an inbound item conveyor associated with the raised position of the insert. The inbound item conveyor may be configured to transport items to the lifting device. The item moving device may be configured to horizontally move an item off the inbound item conveyor such that the item is received onto the insert base via one of the end openings when the insert is in the raised position. The inbound item conveyor may comprise a conveying surface on which items are transported. The conveying surface of the inbound item conveyor may be located at substantially the same height as the insert base, or higher than the insert base when the insert is in the raised position. The inbound item conveyor may be configured to transport items to a location adjacent one of the end openings of the insert channel.

The item transfer system may further comprise a central inbound item conveyor and a plurality of item transfer stations, each item transfer station comprising an inbound item conveyor. The inbound item conveyors of the plurality of item transfer stations may be configured to transport items from the central inbound item conveyor to the lifting device of their respective item transfer station.

The item transfer station may further comprise an outbound item conveyor associated with the raised position of the insert. The outbound item conveyor may be configured to transport items away from the lifting device. The item moving device may be configured to horizontally move an item off the insert base such that the item is received on the outbound item conveyor via one of the end openings when the insert is in the raised position. The outbound item conveyor may comprise a conveying surface on which items are transported. The conveying surface of the outbound item conveyor may be located at substantially the same height as the insert base, or lower than the insert base when the insert is in the raised position. The outbound item conveyor may be configured to receive items at a location adjacent one of the end openings of the insert channel.

The item transfer system may further comprise a central outbound item conveyor and a plurality of item transfer stations, each item transfer station comprising an outbound item conveyor. The outbound item conveyors of the plurality of item transfer stations may be configured to transport items from the lifting device of their respective item transfer station to the central outbound item conveyor.

In the case where the item transfer station comprises both an inbound item conveyor and an outbound item conveyor, the inbound item conveyor may be configured to transport items to a location adjacent one of the end openings of the insert channel, and the outbound item conveyor may be configured to receive items at a location adjacent the other end opening of the insert channel. The item moving device may be configured to horizontally move items from the inbound item conveyor onto the insert base via one of the end openings and horizontally move items from the insert base onto the outbound item conveyor via the other end opening.

The item transfer station may further comprise a de-casing platform and a robotic arm configured to de-case cased items before horizontally moving the items onto the insert base. The de-casing platform may comprise a cutting region comprising one or more cutting blades protruding upwards from the top surface of the de-casing platform, and a suction region comprising apertures extending through the de-casing platform and suction means for creating a downwards suction force. The robotic arm may be configured to move a cased item over the cutting region to cut a bottom portion of the case. The robotic arm may then be configured to horizontally slide the cased item onto the insert base while passing over the suction region to remove the bottom portion from the rest of the case, such that the bottom of the item slides directly onto the insert base. The robotic arm may then be configured to lift the remaining case off the item to leave the de-cased item on top of the insert base.

The item transfer station may further comprise a stacking mechanism for stacking a second item on top of a first item on the insert base. The stacking mechanism may comprise a stacking plate configured to move between a retracted position and an extended position. The lifting device is also further configured to lower the insert from the raised position to a stacking position. After a first item has been horizontally moved onto the insert base using the item moving device while the insert is in the raised position, the insert is then lowered to the stacking position. The second item can be horizontally moved onto the stacking plate using the item moving device and the stacking plate is move to the extended position above the first item. The stacking plate is then moved to the retracted position to leave the second item on top of the first item.

The lifting device may be configured to vertically move the insert between the storage container and a plurality of raised positions. The item transfer station comprises one or more item moving devices configured to horizontally move an item onto and/or off the insert base via the end openings at each raised position. Each raised position may have an associated item moving device, or a single item moving device may be associated with a plurality of raised positions. Each raised position may have an associated inbound item conveyor configured to transport items to the lifting device and/or an associated outbound item conveyor configured to transport items away from the lifting device. For each raised position, the one or more item moving devices may be configured to horizontally move an item off the associated inbound item conveyor such that the item is received on the insert base via one of the end openings, and/or the one or more item moving devices may be configured to horizontally move an item off the insert base such that the item is received on the associated outbound item conveyor via one of the end openings.

The item transfer station may further comprise: an inbound container conveyor configured to transport container units to the lifting device; and an outbound container conveyor configured to transport container units away from the lifting device.

The storage and retrieval system may further comprise a storage area in which a plurality of the container units are arranged in a plurality of vertical stacks. The storage and retrieval system may be configured to transport container units from the storage area to the item transfer station and/or from the item transfer station to the storage area. The container units may be transported from the storage area to the item transfer station via an inbound container conveyor and transported from the item transfer station to the storage area via an outbound container conveyor.

The storage area may comprise a storage structure. The storage structure may comprise a track structure mounted on top of a framework. The track structure may comprise a first set of tracks and a second set of tracks, the first set of tracks extending in a first direction and the second set of tracks extending in a second direction, the second direction being substantially perpendicular to the first direction, to form a grid pattern defining a plurality of grid cells. Each stack of container units may be arranged below a grid cell. The storage and retrieval system may further comprise one or more load handling devices, each load handling device comprising: a driving assembly configured to horizontally move the load handling device on the track structure; a container-holding device configured to releasably hold a container unit from above; and a lifting mechanism configured to raise and lower the container-holding device.

The storage structure may comprise an ingress column and an egress column below the grid cells. The item transfer station may comprise an inbound container conveyor configured to transport container units from the egress column and the lifting device, and an outbound container conveyor configured to transport from the lifting device to the ingress column. A load handling device may deliver a container unit from the grid cell above the egress column onto the outbound container conveyor. The load handling device may pick up a container unit from the ingress column that was transported to the ingress column via the outbound item conveyor.

The container-holding device of the load handling device may comprise grippers. Each storage container may comprise features configured to engage with the grippers to allow the container unit to be lifted by the container-holding device. Examples features include protrusions and/or recesses and/or apertures. For example, each storage container may comprise a rim with apertures configured to receive and engage with the grippers of the container-holding device.

The item to be moved onto and/or off the insert base may be any one of the following: a product, a product sub-container for containing a product, trash, a delivery sub-container for containing customer orders. A sub-container is a container that is configured to fit within the storage container, on the insert.

### BRIEF DESCRIPTION OF THE DRAWINGS

The present invention will now be described, by way of example only, with reference to the accompanying drawings, in which like reference numerals are used for like features, and in which:

FIG. 1 is a perspective view of a container unit comprising an insert nested within a storage container.

FIG. 2 is the container unit of FIG. 1 with the insert raised above the storage container.

FIG. 3A is a top perspective view of the insert of FIG. 1.

FIG. 3B is a bottom perspective view of the insert of FIG. 1.

FIG. 4A is a perspective view of a variation of a container unit comprising an insert nested within a storage container.

FIG. 4B is a perspective view of the container unit of FIG. 4A with the insert raised above the storage container.

FIG. 5 is a perspective view of part of an item transfer station.

FIG. 6 is the item transfer station of FIG. 5 with the insert raised to a raised position.

FIGS. 7A-7C is a sequence of drawings showing the operation of a first item moving device for horizontally moving items off the insert.

FIGS. 8E-8F is a sequence of drawings showing the operation of a second item moving device for horizontally moving items onto and/or off the insert.

FIGS. 9A-9D is a sequence of drawings showing the operation of a third item moving device for horizontally moving items onto and/or off the insert.

FIG. 10 is a perspective view of an item transfer station comprising a stacking mechanism that allows items to be stack on top of each other in an insert.

FIGS. 11A-11F is a sequence of drawings showing the operation of the stacking mechanism.

FIG. 12 is a perspective view of a first example item transfer station for loading products and/or product sub-containers into container units.

FIG. 13 is a perspective view of a second example item transfer station for removing trash from container units.

FIG. 14 is a perspective view of a third example item transfer station for removing trash and/or empty product sub-containers from container units.

FIG. 15 is a perspective view of a fourth example item transfer station for loading products and/or product sub-containers into container units and/or for removing empty sub-containers from container units.

FIG. 16 is a perspective view of a fifth example item transfer station for loading products and/or product sub-containers into container units; and removing trash and/or empty sub-containers from container units.

FIG. 17 is a perspective view of a sixth example item transfer station for loading and/or removing delivery containers onto and/or from container units.

FIG. 18 is a perspective view of a seventh example item transfer station for loading and/or removing multiple types of items onto and/or multiple type of items from container units.

FIG. 19 is a perspective view of an eighth item transfer station comprising a robotic arm and de-cutting platform for de-casing a cased product before moving it into the insert base.

FIGS. 20A-20E are a sequence of drawings that show how the item transfer station of FIG. 19 operates.

FIG. 21 is a perspective view of a grid storage structure and container units.

FIG. 22 is a schematic plan view of a track on top of the storage structure of FIG. 21.

FIG. 23 shows load handling devices on top of the storage structure of FIG. 21.

FIG. 24 is a perspective view of a single load handling device with a lifting mechanism in a lowered configuration.

FIG. 25 is a schematic cutaway view of the load handling device of FIG. 24 with the lifting mechanism in a lowered configuration.

FIG. 26 is a perspective view of the storage structure of FIG. 21 linked to an item transfer station.

### DETAILED DESCRIPTION

### Container Unit

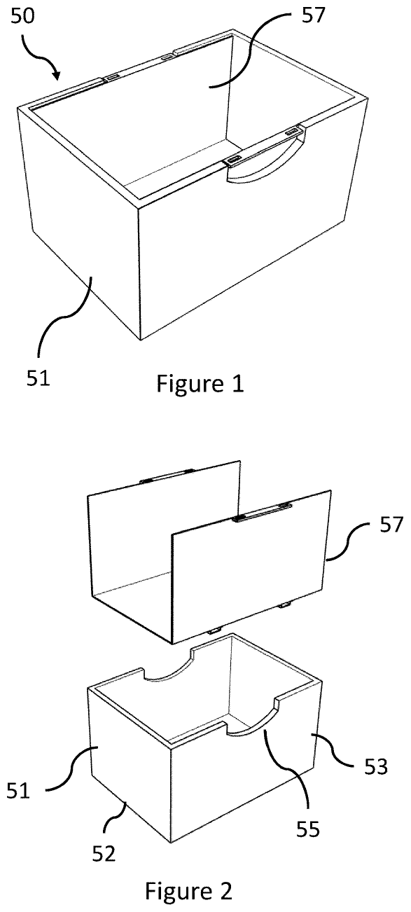

FIG. 1 shows a container unit 50. The container unit 50 comprises a storage container 51 and an insert 57 nested within the storage container 51. The term “container unit” will be used in this specification to refer to the combination of an insert 57 nested within a storage container 51.

The storage container 51 has a rectangular container base 52 and container sidewalls 53 extending upwardly from the base 52 to define a top opening 54. The storage container 51 may comprise features that allow the storage container 51 to be handled by a load handling device (described later).

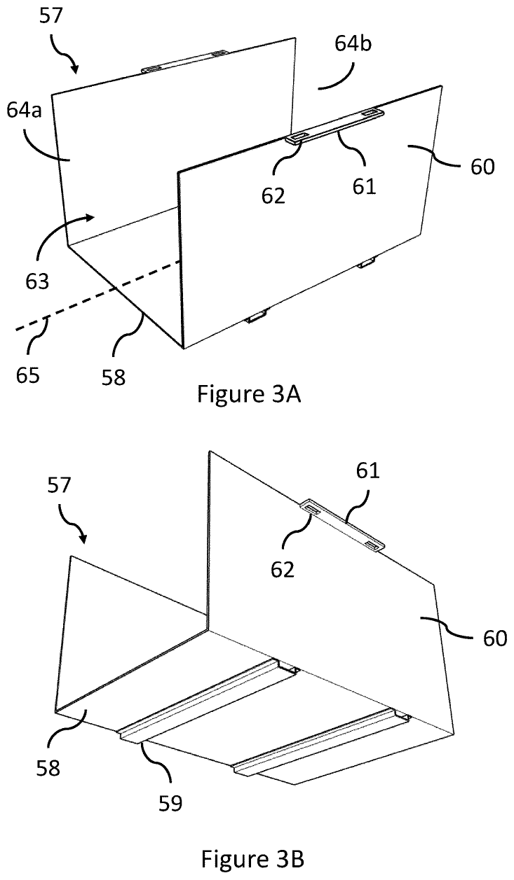

FIG. 2 shows the insert 51 in a position vertically above the storage container 51 and FIG. 3A and FIG. 3B show the insert 57 in isolation from a top perspective view and a bottom perspective view respectively. The insert 57 comprises a rectangular insert base 58 and two opposing insert sidewalls 60 extending upwardly from the insert base 58. The insert base 58 and the insert sidewalls 60 are substantially planar and form a U shape that defines a horizontally extending insert channel 63 having two opposing end openings 64a, 64b that oppose each other in a horizontal direction. The U shaped insert also defines a horizontal longitudinal axis 65 running through the end openings 64a, 64b. The insert 57 is open at the top (or at least comprises a top opening).

The insert base 58 is sized in the width and length dimension so that the insert 57 can be inserted into the storage container 52 via the top opening 55 of the storage container 52. The insert base 57 is also preferably sized such that the width and length is similar to that of the container base 52. The insert sidewalls 60 preferably do not extend above the top of the storage container 51. The insert base 58 and sidewalls 60 may be substantially rigid and may be made of, for example, a metal material. The insert base 58 may be made from or coated in a material that provides a low-friction surface to allow items to slide relatively easily across the surface of the insert base 58. For example, the coefficient of friction of a particular item sliding on the low-friction surface of the insert base 58 may be lower than the coefficient of friction of that same item sliding on the container base 52.

Each of the insert sidewalls 60 comprises a handle 61 that extends horizontally outwards (i.e. in a direction away from the longitudinal axis 65 of the insert channel 63). The insert 57 can be lifted out of and lowered back into the storage container 51 by engaging the handles 61 and lifting and lowering the insert 57 relative to the storage container 51 respectively. Each handle 61 comprises one or more handle recesses 62 extending vertically upwards from a bottom surface of the handle 61 for receiving corresponding protrusions of a lifting device 74 (described later). The recesses 62 are shown as vertically extending completely through the handles 61, but alternatively they may vertically extend only partially through the handles 61.

When the insert 57 is nested within the storage container 51, the insert handles 61 protrude horizontally into spaces in the container sidewalls 53 defined by cutouts 55 extending downwards from the top of the container sidewalls 53. In this way, the handles 61 do not take up volumetric storage space within the storage container 51 or within the insert channel 63, which allows the insert channel 63 to be larger to hold more items or larger items. The handles 61 preferably do not horizontally protrude past the outer surface of the container sidewalls 53.

As shown in FIG. 3B, the underside of the insert base 58 comprises a plurality of ribs 59 extending across the underside of the insert base 58 in a direction perpendicular to the longitudinal axis 65 of the insert channel 63 to help strengthen and reinforce the insert base 58.

In use, items stored in a container unit 50 are carried within the insert 57, rather than directly in the storage container 51. Thus, when the insert 57 is lifted out of the storage container 51, any items stored in the container unit 50 are also lifted out with the insert 57.

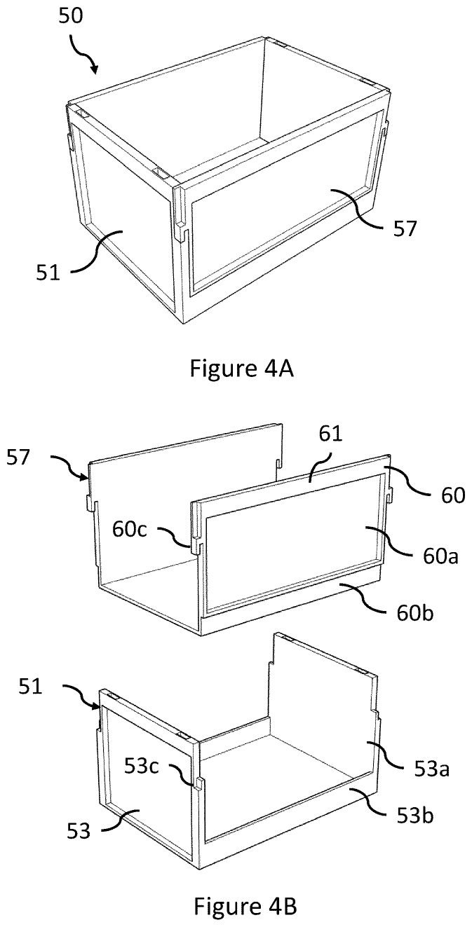

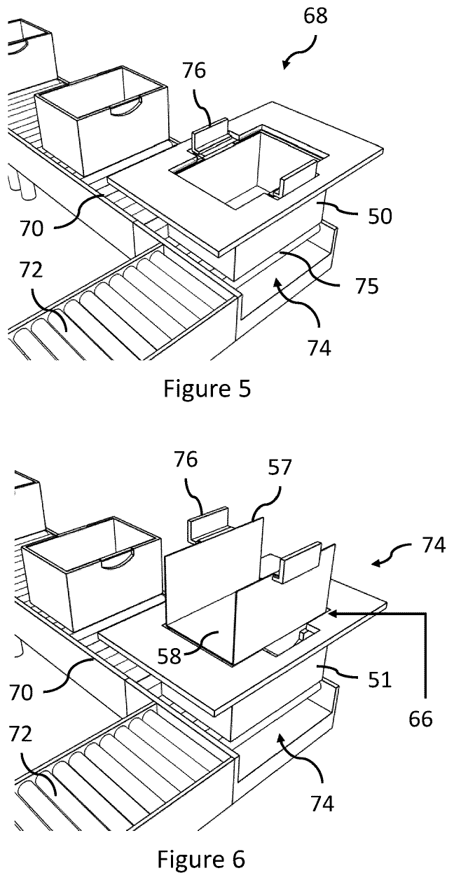

FIG. 4A shows a variation of the container unit 50 with the insert 57 nested in the storage container 51 and FIG. 4B shows the insert 57 in a position vertically above the storage container 51. In this variation, the insert sidewalls 60 are contiguous with the container sidewalls 53 to define the external sidewalls of the container unit 50. In particular, the storage container 51 comprises two taller opposing container sidewalls 53 and two shorter opposing container sidewalls 53b which are arranged in a rectangular shape to define two opposing container side openings 53a. The insert base 58 and a lower portion 53b of the insert sidewalls 60 are sized and configured to nest within the storage container 51. However, an upper portion 60a of each insert sidewall 60 extends horizontally outwards with respect to the lower portion 60b such that each upper portion 60a occupies a respective side opening 53a when the insert 57 is nested within the storage container 51. In this way, the insert sidewalls 60 and the container sidewalls 53, 53b form a contiguous structure (i.e. the external sidewalls of the container unit 50) when the insert 57 is nested within the storage container 51.

As shown in FIG. 4B, a portion of the external face of the insert sidewalls 60 may be recessed inwards to form handles 61 (i.e. a horizontally protruding portion) which can be engaged to vertically move the insert 57 into and out of the storage container 51.

One of the advantages of this variation is that the overall container unit 50 can be made lighter and cheaper compared to the container unit 50 described above in relation to FIG. 1 because the storage container 51 comprises less material. The bottom of the insert 57 is still nested within the storage container 51 in this variation which helps to prevent the insert 57 from sliding out of or away from the storage container 51 in a horizontal direction. To help further prevent unwanted relative movement between the insert 57 and the storage container 51 and to stabilize the structure of the container unit 50, the insert sidewalls 60 are configured to interlock the taller container sidewalls 53 in a vertical direction, at the vertical edges (between the corners) of the container unit 50. In the example shown in FIGS. 4A and 4B, each vertical edge of the insert sidewalls 60 comprises a downwardly extending protrusion 60a which is received into a corresponding recess or cutout 53b in a respective vertical edge of the taller container sidewalls 53 such that the insert sidewalls 60 and the container sidewalls 53 interlock at the vertical edges of the container unit 50.

### Item Transfer Station

FIG. 5 shows part of an item transfer station 68 that operates with container units 50 to load and/or unload items from the container units 50 by transferring items onto and/or off the inserts 57.

The item transfer station 68 comprises a lifting device 74. The lifting device 74 may comprise a frame or other mounting surfaces to mount components, but these are not shown in the figures for clarity. The lifting device 74 is configured to receive a container unit 50 at a bottom portion 75 of the lifting device 74. In this example, container units 50 arrive at the lifting device 74 via an inbound container conveyor 70 and leave the lifting device 74 via an outbound container conveyor 72. The inbound and outbound container conveyors 70, 72 are joined to form a continuous path that passes through the bottom portion 75 of the lifting device 74. The container units 50 are arranged on the inbound container conveyor 70 such that each container unit 50 arrives at the bottom portion 75 of the lifting device 74 with the longitudinal axis 65 of the insert channel 63 orientated in the same direction.

The lifting device 74 is configured to lift an insert 57 out of a storage container 51 to a raised position 66 once the container unit 50 is stationary at the bottom portion 75 of the lifting device 74. FIG. 6 shows the insert 57 after it has been lifting to the raised position 66. The lifting device 74 comprises a pair of opposing lifting members 76 that are located on either side of the container unit 50 where the insert handles 61 are located. Each lifting member 76 comprises a horizontally extending engaging portion with upwardly extending protrusions (not shown) configured to be received in the recesses 62 of the insert handles 61 when the lifting members 76 engage the insert handles 61 from below. Each lifting member 76 is configured to move in a vertical direction relative to the storage container 51. For example, each lifting member 76 may be movable along one or more vertical rails (not shown) using known means such as a belt drive. Each lifting member 76 is also configured to move towards and away from the container unit in a horizontal direction (e.g. using a linear actuator).

To lift the insert 57 out of the storage container 51, the lifting members 76 are moved to a vertical position below the insert handles 61. The lifting members 76 are then moved horizontally towards the container unit 50 until they are directly below the insert handles 61.

The lifting members 76 are then moved upwards, which causes them to engage the insert handles 61 from below and causes the lifting member protrusions to be received in the insert handle recesses 62. The lifting members 76 can then be moved further upwards to lift the insert 57 out of the storage container 51 to the raised position 66 at which the insert base 58 is above the top of the storage container 51. To lower the insert 57 back into the storage container 51, the lifting members 76 are moved downwards until the insert 57 is nested back inside the storage container 51. The lifting members 76 are then moved further downwards to disengage them from the insert handles 61, and then moved horizontally away from the container unit 50. The container unit 50 can then leave the lifting device 74 via the outbound container conveyor 86.

The item transfer station 68 further comprises an item moving device 78 for transferring items onto and/or off the insert 57 via the end openings 64a, 64b when the insert 57 is in the raised position 66. The item moving device 78 is configured to apply a horizontal force to an item in a direction parallel to the longitudinal axis of the insert channel to move the item in a horizontal direction onto and/or off the insert 57.

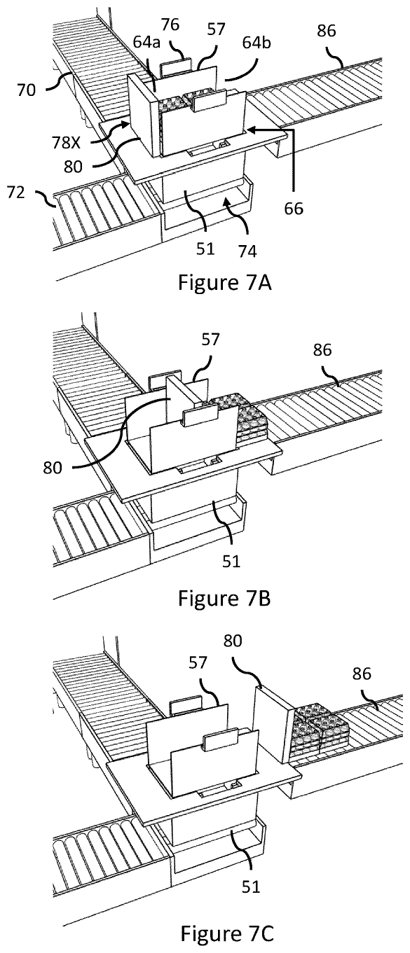

FIGS. 7A-7B show a first item moving device 78X that can push items off the insert base 58 when the insert 57 is in the raised position 66. The first item moving device 78 may be mounted on a platform or a frame or any other suitable mounting surface. The item transfer station comprises an outbound item conveyor 86 that receives items that have been pushed off the insert base 58 and transports the items away from the lifting device 74. As shown in FIG. 7A, the first item moving device 78X comprises a pushing member in the form of a vertically orientated pushing plate 80 with a pushing surface orientated perpendicular to the longitudinal axis 65 of the insert channel 63. The pushing plate 80 is linearly movable (e.g. using a linear actuator) in a horizontal direction parallel to the longitudinal axis of the insert channel. The pushing plate 80 is located at substantially the same level as the raised position 66 of the insert 57, adjacent to a first end opening 64a of the insert channel 63. As shown in FIGS. 7B and 7C, the pushing plate 80 is moved in a horizontal direction through the insert channel 63 via the first end opening 64a in order to push any items that are on the insert base 58 out of the insert channel 63 via an opposing second end opening 64b. The outbound item conveyor 86 is located on the same side of the insert 57 as the second end opening 64b such that any items pushed out of the insert 57 via the second end opening 64b are received by the outbound item conveyor 86.

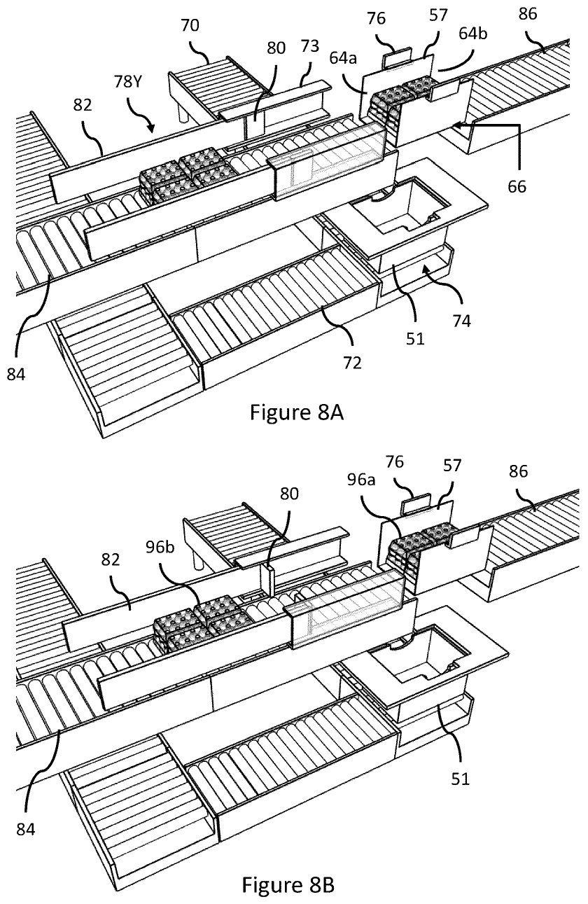

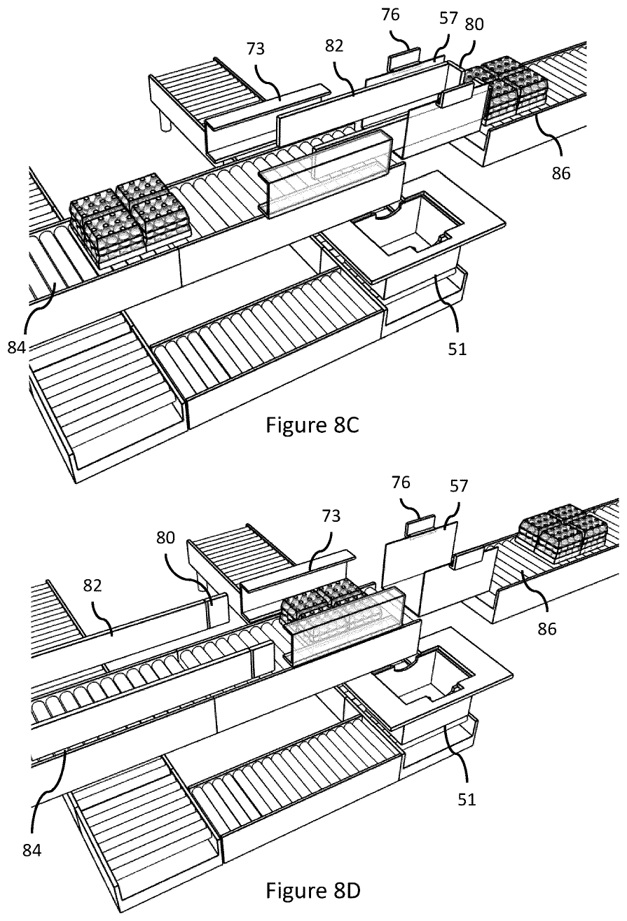

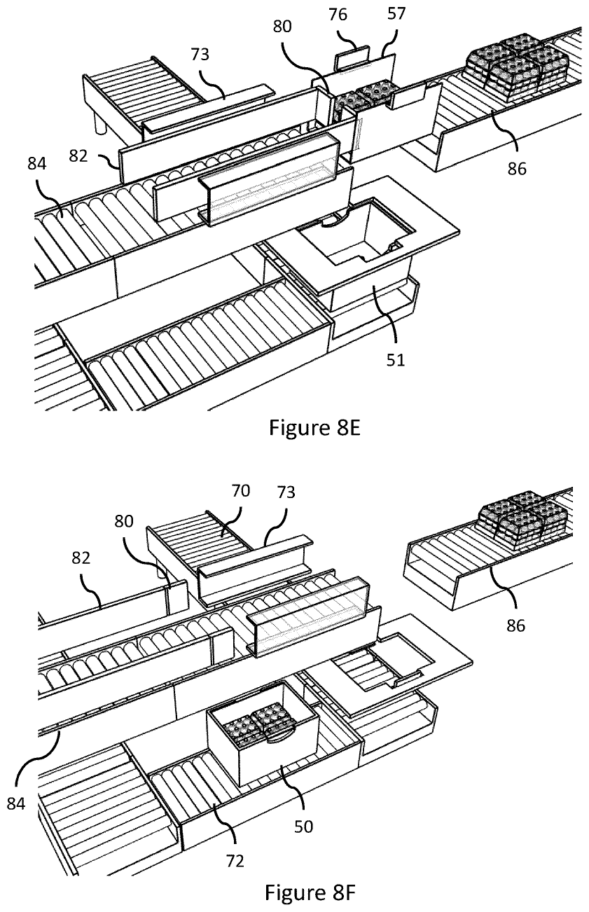

FIGS. 8A-8F show a second item moving device 78Y that can push items onto the insert base 58 and/or off the insert base 58 when the insert 76 is in the raised position 66. In this example, items are transported to the lifting device 74 via an inbound item conveyor 84 and are transported away from the lifting device via an outbound item conveyor 86 associated with the raised position 66 of the insert 57. The inbound item conveyor 84 is configured to transport items to a first end opening 64a of the insert channel 63 and the outbound item conveyor 86 is configured to receive items from an opposing second end opening 64b of the insert channel 63.

The second item moving device 78Y comprises a pair of vertically orientated pushing plates 80 that oppose each other on either side of the inbound item conveyor 84, in the vicinity of the first end opening 64a. The second item moving device 78Y may be mounted to a frame or any other suitable mounting surface. Each pushing plate 80 is pivotally mounted to a support member 82 for rotational movement about a vertical pivot axis, e.g. using rotational actuators. The pushing plates 80 are rotatable about their respective pivot axes between an open position in which the pushing plates 80 are orientated parallel to the longitudinal axis 65 of the insert channel 63 and a closed position in which the pushing plates 80 are orientated perpendicular to the longitudinal axis 65 of the insert channel 63. In the open position, the pushing plates 80 are laterally spaced far enough to allow items on the inbound item conveyor 84 to pass between them. To move to the closed position, the pushing plates 80 are rotated inwards towards each other (towards the longitudinal axis of the insert channel). In the closed position, the pushing plates 80 block the path of items being transported by the inbound item conveyor 84. The pushing plates 80 are further linearly movable in a direction parallel to the longitudinal axis 65 of the insert channel 63 (e.g. using linear actuators), such that the pushing plates 80 can be moved through the insert channel 63 via the first end opening 64a. The pushing plates 80 may also be movable towards and away from other in a direction perpendicular to the longitudinal axis 65 of the insert channel 63, which may be required if the distance between the pushing plates 80 needs to be narrowed in order for the pushing plates 80 to fit within the insert channel 63. For example, the second item moving device 78Y may comprise linear actuators for selectively moving the pushing plates towards and away from each other, or the pushing plates 80 may be mounted on rails for movement in a direction parallel to the longitudinal axis of the insert channel, where the rails are configured to get closer together towards the insert 57.

The item transfer station 68 optionally further comprises a pair of alignment members 73 that oppose each other on either side of the inbound item conveyor 84, in the vicinity of the first end opening 64a. The alignment members 73 are movable towards each other (e.g. using a linear actuator) in a horizontal direction perpendicular to the longitudinal axis 65 of the insert channel 63 such that any item located between the alignment members 73 is centred about the longitudinal axis 65 of the insert channel 63. This helps to ensure that an item is in the correct position relative to the insert channel 63 to allow the item to be pushed onto the insert base 58 via the first end opening 64a by the pushing plates 80.

In use, a first item 96a can be transferred off the insert base 58 when the insert 57 is in the raised position 66 by rotating the pushing plates 80 to the closed position (FIG. 8B) and moving the pushing plates 80 through the insert channel 63 via the first end opening 64a such that the first item 96a is pushed off the insert base 58 onto the outbound item conveyor 86 via the second end opening 64b (FIG. 8C).

While the insert 57 remains in the raised position 66, a second item 96b can then be transferred from the inbound item conveyor 84 onto the insert base 58 by transporting the second item 96b to a position adjacent to the first end opening 64a, rotating the pushing plates 80 back to the open position, moving the pushing plates 80 back to a position behind the second item 96b and moving the alignment members towards each other to centre the second item 96b about the longitudinal axis (FIG. 8D). The pushing plates 80 can then be rotated to the closed position and moved the through the insert channel 63 via the first end opening 64a to push the second item 96b onto the insert base 58 (FIG. 8E.

After the item transferring operations are complete, the insert 57 is lowered back into the storage container 51 and the container unit 50 is transported away from the lifting device 74 via the outbound container conveyor 86 (FIG. 8F). A new container unit 50 can then arrive at the lifting device 74 to repeat the process.

The second item moving device 78Y does not need to transfer a new item onto the insert 57 after an item has been transferred off the insert 57 if the container unit 50 is to remain empty when it leaves the lifting device 74. Similarly, if the container unit 50 is empty when it arrives at the lifting device 74, the second item moving device 78Y can be used to just transfer an item onto the insert 57

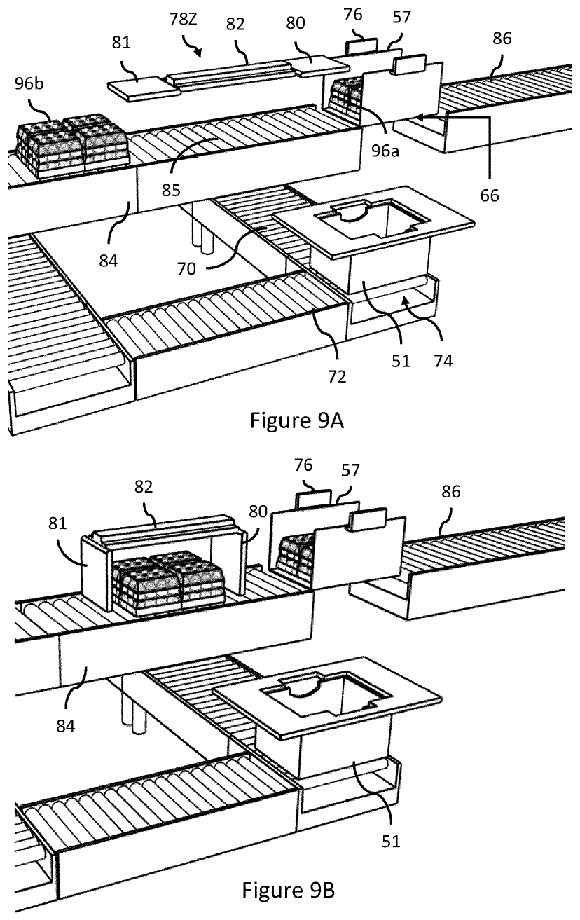

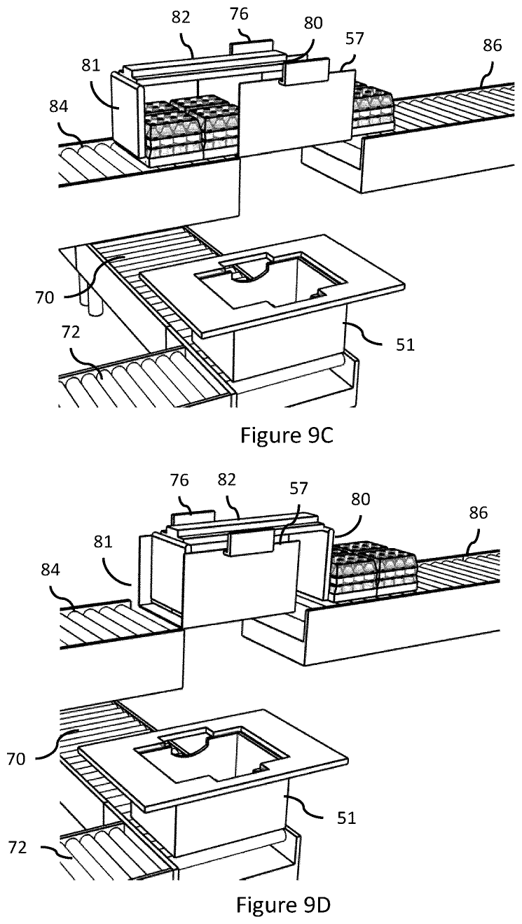

FIGS. 9A-9D show a third item moving device 78Z that can push items onto the insert base 58 and/or off the insert base 58 when the insert 57 is in the raised position 66. The third item moving device 78Z is mounted above the inbound item conveyor 84, e.g. on a frame (not shown) or any other suitable mounting surface. The third item moving device 78Z comprises a support member 82 with a first pushing plate 80 pivotally mounted at one end of the support member 82 for rotation about a first horizontal pivot axis, and a second pushing plate 81 pivotally mounted at an opposing end of the support member 82 for rotation about a second horizontal pivot axis. The first pushing plate 80 and the second pushing plate 81 are rotatable downwards about their respective pivot axes from a horizontal orientation to a vertical orientation and back again. The first and second pushing plates 80, 81 may be mechanically linked to a single rotational actuator such that they rotate simultaneously, or each pushing plate 80, 81 may be provided with its own rotational actuator so that the first and second pushing plates 80, 81 can be rotated independently.

The third item moving device 78Z is configured such that the pivot axes of the first pushing plate 80 and the second pushing plate 81 are aligned parallel to each other and are aligned perpendicular to the longitudinal axis 65 of the insert channel 63. The first and second pushing plates 80, 81 are arranged along the longitudinal axis of the insert channel, with the first pushing plate 80 being located closer to the first end opening 64a of the insert channel 63 than the second pushing plate 81.

In the horizontal orientation, the first pushing plate 80 and the second pushing plate 81 are orientated parallel to the conveying surface 85 of the inbound item conveyor 84 and are located high enough above the conveying surface 85 such they do not block the items being conveyed by the inbound item conveyor 84. In the vertical orientation, the first pushing plate 80 and the second pushing plate 81 are orientated perpendicular to the conveying surface 85 of the inbound item conveyor 84 such that they block the path of the items being conveyor by the inbound item conveyor 84. However, the space between the first and second pushing plates 80, 81 in a direction parallel to the longitudinal axis 65 of the insert channel 63 is large enough such that an item being conveyed by the inbound item conveyor can fit between the first and second pushing plates 80, 81.

The support member 82 is moveable in a horizontal direction (e.g. using a linear actuator) in a direction parallel to the longitudinal axis 65 of the insert channel 63 to the extent that the first pushing plate 80 is moved through the insert channel 63 via the first end opening 64a to push any items that are on the insert base 58 out of the insert channel 63 via the second end opening 64b.

In use, the first and second pushing plates 80, 81 are initially horizontally orientated and the insert 57 of a container unit 50 at the lifting device 74 is lifted to the raised position 66 (FIG. 9A). The insert 57 may already hold a first item 96a. The inbound item conveyor 84 conveys a second item 96b towards the insert 57 until the second item 96b is located between the pivot axes of the first and second pushing plates 80, 81. The first and second pushing plates 80, 81 are then rotated downwards to the vertical orientation (FIG. 9B). The first and second pushing plates 80, 81 are then moved horizontally through the insert channel 63 in a direction parallel to the longitudinal axis 65 of the insert channel 63 such that the first pushing plate 80 pushes the first item 96a off the insert base 63 onto the outbound item conveyor 86 via the second end opening 64b, and the second pushing plate 81 simultaneously pushes the second item 96b off the inbound item conveyor 84 onto the insert base 58 via the first end opening 64a (FIG. 9C-9D). The insert 57 is then lowered back into the storage container 51, the container unit 50 is transported away from the lifting device 74 by the outbound container conveyor 72, and the first and second pushing plates 80, 81 are rotated back to the horizontal orientation. The process can then be repeated with a new container unit 50 and a new item arriving at the lifting device 74 via the inbound item conveyor 84.

Similar to the item transfer station 68 shown in FIGS. 8A-8F, the item transfer station 68 in this example could also comprise a pair of alignment members 73 for centring items on the inbound item conveyor 84 about the longitudinal axis 65 of the insert channel 63. The alignment members 73 may be activated before or while the second pushing plate 81 pushes an item off the inbound item conveyor 84 onto the insert base 58.

It can be seen that the third item moving device 78Z allows a first item to be transferred off the insert 57 and a second item to be transferred onto the insert 57 substantially simultaneously. However, the third item moving device 78Z can also be used to perform only one of these operations for a particular container unit 50. For example, if an insert 57 is already empty when its container unit 50 arrives at the lifting device 74, then the third item moving device 78Z can be used to just transfer an item onto the insert 57, or if an insert 57 already contains an item but does not need to be loaded with a new item, then the third item moving device 78Z can be used to just transfer the item off the insert 57. In these cases, only one of the first and second pushing plates 80, 81 needs to be rotated to the vertical orientation as appropriate.

The item moving device 78 of the present invention is not intended to be limited to the precise forms of the examples described above. Modifications of the above example item moving devices, or other item moving devices for horizontally moving items onto and off the insert via the end openings will be apparent to the skilled person. Some example modifications are described below.

The pushing members 80 of the item moving device 78 do not need to in the form of plates, as long as they comprise a suitable pushing surface for pushing items in a horizontal direction.

Instead of the second item moving device 78Y having a pair of pushing plates 80 the second item moving device could instead have only one pushing plate 80 located on one side of the longitudinal axis 65 of the insert channel 63. In this variation, the single pushing plate is wide enough such that when the pushing plate 80 is rotated to the closed position, it can sufficiently engage an item to push it when the pushing plate 80 is moved towards the insert 57.

The second item moving device 78Y can be modified to allow it to simultaneously transfer a first item off the insert base 57 and transfer a second item onto the insert base 58 in a similar manner to the third item moving device 78Z. For example, the second item moving device 78Y can comprise a second pair of pushing plates spaced away from the first pair of pushing plates in a direction parallel to the longitudinal axis of the insert channel. This modified arrangement is effectively equivalent to duplicating the third item moving device and rotating the duplicates by 90 degrees in opposite directions about the longitudinal axis 65 of the insert channel 63. The two pairs of pushing plates are spaced far enough apart in a direction parallel to the longitudinal axis 65 of the insert channel 63 such that an item being conveyed by the inbound item conveyor 84 can fit between the pivot axes of the two pairs of pushing plates. Thus, when the first and second pairs of pushing plates are rotated to a closed position and moved towards the insert channel 63, the first pair of pushing plates enter the insert channel 63 to push the first item off the insert base 58 onto the outbound item conveyor via the second end opening 64b, and the second pair of pushing plates push the second item off the inbound item conveyor 86 onto the insert base 58 via the first end opening 64a. This variation of the second item moving device 78Y can also be modified to remove one of the pushing plates from each of the first pair and the second pair of pushing plates such that only one pushing plate is used to push items off the insert base 58 and only one pushing plate is used to push items off the inbound item conveyor 84. These pushing plates may be arranged on the same side of the longitudinal axis 65 of the insert channel 63, or on opposing sides.

The third item moving device 78Z may be modified to remove either the first pushing plate 80 or the second pushing plate 81 such that it operates similarly to the second item moving device 78Y, i.e. transferring an item off the insert 57 and transferring an item onto the insert 57 are performed as consecutive operations.

The third item moving device 78Z does not necessarily require a support member 82 connecting the two pushing plates 80, 81. Instead, each pushing plate 80, 81 may be independently mounted to a linear actuator such that linear movement of each pushing plate 80, 81 can be controlled separately.

Instead of the item moving device 78 being located on the same side of the insert 57 as the inbound item conveyor 84, the item moving device 78 could be located on the same side of the insert 57 as the outbound item conveyor 86. The item moving device 78 could also be part of the lifting device 74. For example, the item moving device 78 could be mounted on the lifting device 74 above the lifting members and the lifting device 74 could be configured to vertically lift the item moving device 78 together with, or independently of, the insert 57, such that when the insert 57 is lifted to the raised position 66, the item moving device 78 is at an appropriate height to perform an item moving operation.

In order to allow an item to be transferred onto or off the insert base 57 by applying only a horizontal force to the item, the inbound item conveyor 84 (more specifically, the conveying surface 85 of the inbound item conveyor 84) should be substantially level with, or above, the level of the insert base 58 when the insert 57 is in the raised position 66, and the outbound item conveyor 86 (more specifically, the conveying surface of the outbound item conveyor 86) should be substantially level with, or below the level of the insert base 58 when the insert 57 is in the raised position 66.

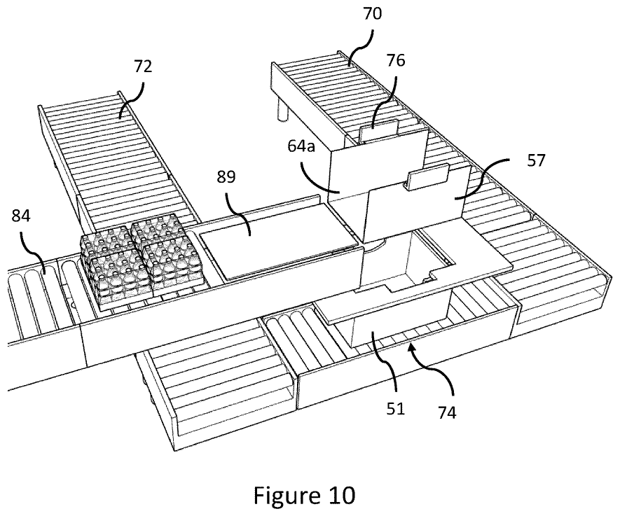

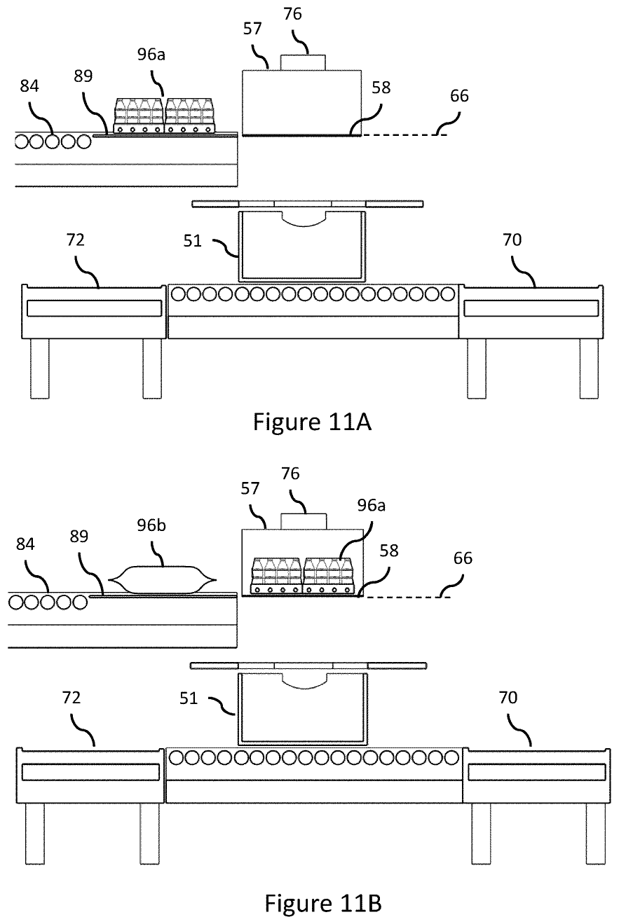

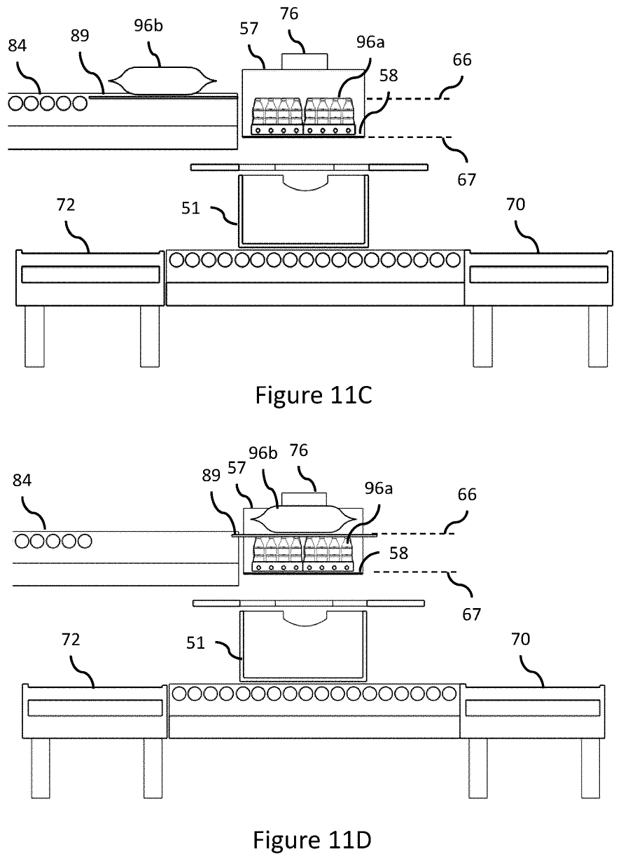

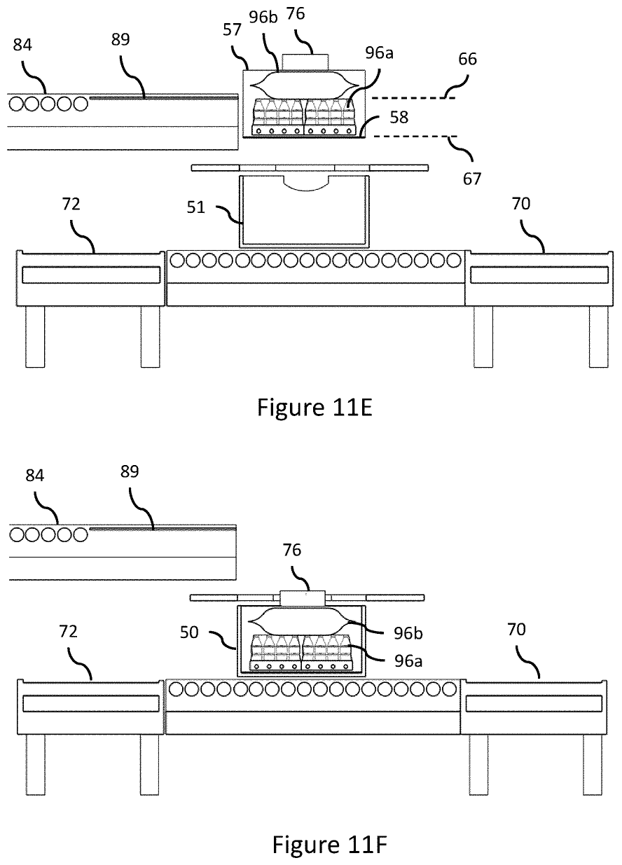

FIG. 10 and FIGS. 11A-11F show an example of an item transfer station 68 that allows multiple items to be transferred from an inbound item conveyor into the same insert 57 in multiple layers, i.e. it allows items to be vertically stacked in the insert 57. In this example, in addition to the raised position 66, the lifting device 74 is also configured to vertically move the insert 57 to a stacking position 67 which is lower than the raised position 66. The item transfer station 68 further comprises a stacking mechanism comprising a stacking plate 89 which is located at the end of the inbound item conveyor 84, adjacent to one of the end openings 64a. The stacking plate 89 is orientated parallel to the insert base 58. The stacking plate 89 is horizontally moveable (e.g. using a linear actuator) in a direction parallel to the longitudinal axis 65 of the insert channel 63 between a retracted position and an extended position in which the insert 57 extends into the insert channel via a first end opening 64a (when the insert 57 is in the stacking position 67). For clarity, an item moving device 78 is not shown in FIGS. 10 and 11A-11F, but any item moving device 78 suitable for moving items horizontally, such as the ones described above, may be used in this example.

In use, the insert 57 from a container unit 50 at the lifting device 74 is lifted to the raised position 66 (FIG. 11A). An item moving device 78 (not shown) horizontally pushes a first item 96a from the inbound item conveyor 84 onto the insert base 58 (FIG. 11B). The lifting device 74 then lowers the insert 57 to the stacking position 67 and a second item 96b is transported onto the stacking plate 89 (FIG. 11C). The stacking plate 89 is then move to the extended position such that the stacking plate 89 extends over the top the first item 96a (FIG. 11D). The stacking plate 89 is then be retracted such that the second item 96b is left sitting on top of the first item 96a (FIG. 11E). To avoid the second item 96b horizontally moving with the stacking plate 89 when the stacking plate 89 is retracted, the item moving device 78 may remain in position after pushing the second item 96b onto the stacking plate 89 to block the second item 96b from moving backwards. The insert 57 is then lowered back into the storage container 51 and the container unit 50 leaves the lifting device 74 via the outbound container conveyor 72 (FIG. 11F).

To stack items in more than two layers, the above process can be repeated by moving the insert 57 using a plurality of stacking positions 67, provided that there is enough vertical space in the insert 57 to continue stacking items.

The item transfer station 68 of the present invention is also not limited to transferring items onto and off the insert at only a single raised position 66. The lifting device 68 may be configured to lift the insert 57 to any one of a plurality of raised positions 66. At each raised position 66, items may be transferred onto and/or off the insert 57 as appropriate. For example, each raised position 66 may have an associated inbound item conveyor 84 and/or an associated outbound item conveyor 86. The inbound item conveyors 84 may all be arranged on the same side of the insert 57, or on different sides of the insert 57, depending on the flow of items throughout the wider system. Similarly, the outbound item conveyors 86 may all be arranged on the same side of the insert 57, or on different sides of the insert 57, depending on the flow of items throughout the wider system. Each raised position 66 may also have an associated item moving device 78, or the item transfer station 68 may comprise a single item moving device 78 that moves up and down with the insert 57 (e.g. it may be mounted above the lifting members 76 so that the lifting members 76 and the item moving device 78 move vertically together, or the item moving device 78 may be configured for vertical movement independent of the lifting members 76). One or more of the raised positions 66 may also have an associated stacking mechanism as described above for vertically stacking items in multiple layers on an insert 57. An item transferred onto the insert 57 at one raised position may be stacked with an item transferred onto the insert 57 at another raised position. Depending on what items need to be transferred onto or off the insert 57, the insert 57 may be lifted to one or more raised positions 66 for one or more item transfer operations before being lowered back into the storage container 51.

Although the above example item transfer stations use conveyors to transport items and container units to and from the item transfer station, alternative transporting means could be used instead. For example, vehicles, e.g. automated vehicles, may transport items and/or container units to and from the item transfer station. An item moving device 78 may move items directly from the vehicle onto the insert base 58 and vice versa, or the vehicle may place the items onto a holding shelf from which items are moved onto the insert base 58 and vice versa.

### Storage and Retrieval System

The container unit 50 and item transfer station 68 may be used within a storage and retrieval system in which container units 50 are used to store products to be sold to customers. The products 96 may be stored directly in the container units 50 (on the insert 57), or the products 96 may be contained in product sub-containers 97 which are stored in the container units 50 (on the insert 57). The product sub-containers 97 are similar to the storage containers 51 in that they comprise a base and sidewalls which define a top opening, but the product sub-containers 97 are smaller than the storage containers 51 to allow the product sub-containers 97 to fit inside the storage containers 51 (on the insert 57). The container units 50 may be stored in a storage area, e.g. a grid storage structure, an example of which will be described later.

To fulfil a customer order, a container unit 50 containing a product 96 from the order may be retrieved from the storage area and transported to a picking station. At the picking station, the ordered product 96 is picked from the container unit 50 and placed into a delivery sub-container 98 (by a human or a robotic arm, for example). Once all of the products 96 in an order have been picked into a delivery sub-container 98, the delivery sub-container 98 may leave the storage and retrieval system for delivery to a customer (e.g. by a delivery vehicle). For operational efficiency reasons, delivery sub-containers 98 containing completed orders may not be sent to a customer straight away. Instead, delivery sub-containers 98 may be stored in container units 50 within the storage area. The delivery sub-containers 98 are similar to the storage containers 51 in that they comprise a base and sidewalls which define a top opening, but the delivery sub-containers 97 are smaller than the storage containers 51 to allow the delivery sub-containers 98 to fit inside the storage containers 51 (on the insert 57).

Container units 50 within the storage and retrieval system can therefore be empty (i.e. a storage container 51 with an insert 57 but no other items), or may contain a plurality of types of items, including, but not limited to: products 96, product sub-containers 97, and delivery sub-containers 98. The product sub-containers 97 may contain products 96, or may be empty if all of the products 96 within the product sub-container 97 have been picked to fulfil customer orders. The delivery sub-containers 98 may be “empty” (defined as containing no ordered products 96, but may contain shipping packaging (e.g. carrier bags) for orders to be placed inside), or may contain ordered products 96. Container units 50 may also contain items that are considered as “trash”, e.g. pieces of product packaging left behind in a container unit after all the products 96 within the container unit 50 have been picked, or other debris. It is not desirable for trash items to remain in container units 50 because they may interfere with storage capacity and product picking and therefore trash items are typically removed before container units 50 are refilled with new items.

One or more item transfer stations 68 can be used to transfer these items into and/or out of container units 50 within the storage and retrieval system. The storage and retrieval system may comprise transporting means, e.g. conveyors, for transporting items and container units 50 between the one or more item transfer stations 68, the storage area and other areas of the system.

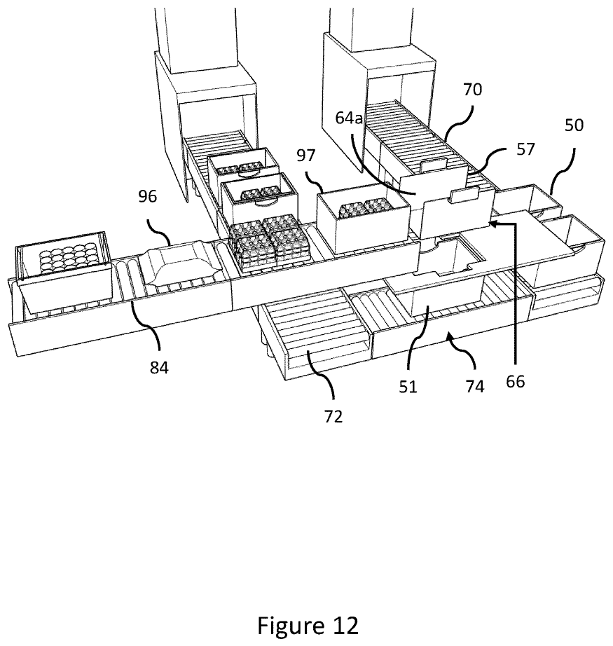

FIGS. 12 to 17 illustrate several ways in which the item transfer station 68 can be used in the context of the storage and retrieval system described above. In the following examples, none of the figures show an item moving device 78 to improve clarity. However, any suitable item moving device or devices 78 for horizontally moving items may be used, such as the ones already described above.

FIG. 12 shows a first example item transfer station 68 configured to operate as a filling station for loading products 96 and/or product sub-containers 97 containing products 96 into container units 50.

The first item transfer station 68 comprises an inbound item conveyor 84 associated with the raised position 66 of the insert 57. The inbound item conveyor 84 is configured to transport products 96 and product sub-containers 97 to one of the end openings 64a of the insert channel 63. When the insert 57 is lifted to the raised position 66, an item moving device 78 (not shown) horizontally pushes a product 96 or a product sub-container 97 off the inbound item conveyor 78 onto the insert base 58 via the end opening 64a. The insert 57 is then lowered back into the storage container 51 and the container unit 50 is transported to the storage area via an outbound container conveyor 72.

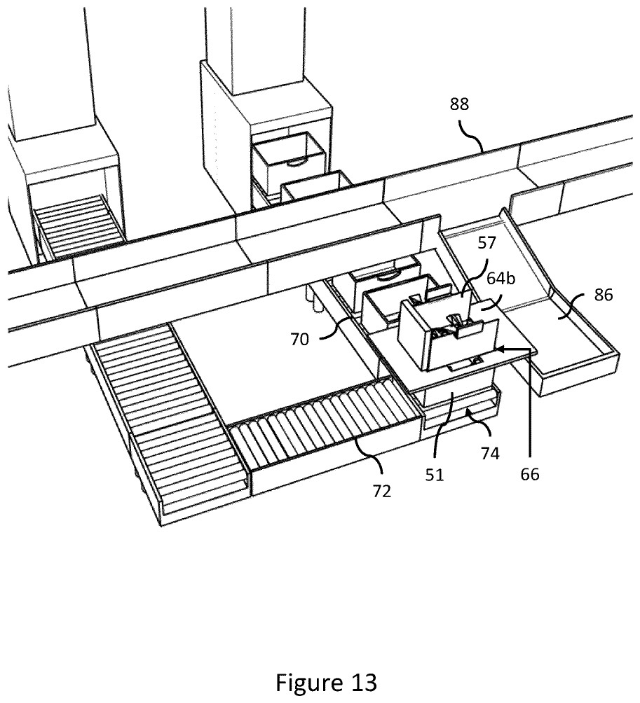

FIG. 13 shows a second example item transfer station 68 for removing trash (e.g. unwanted packaging and other unwanted debris) from container units 50. The second transfer station may be used to clean container units 50 before they are re-used within the system (e.g. re-filled with an item).

The second item transfer station 68 comprises an outbound item conveyor 86 associated with the raised position 66 of the insert 57. The outbound item conveyor 86 is configured to receive trash from one of the end openings 64b of the insert 57 and transport the trash away from the lifting device 74. When the insert 57 is lifted to the raised position 66, an item moving device 78 is horizontally moved through the insert channel so that any items of trash on the insert base 58 are horizontally pushed off the insert base 58 onto the outbound item conveyor 86 via the end opening 64b. The insert 57 is then lowered back into the storage container 51 and the now-cleaned container unit 50 can be transported to another area of the storage and retrieval system via an outbound container conveyor 72.

The outbound item conveyor 86 may feed into a central outbound item conveyor 88. The central outbound item conveyor 88 may be configured receive trash from a plurality of outbound item conveyors 86 from a plurality of item transfer stations 68. This configuration of a central outbound item conveyor 88 that received items from a plurality of outbound item conveyors 86 from a plurality of item transfer stations 68 may be used for any type of item (e.g. product sub-containers 97 and delivery sub-containers 98), not just trash. Similarly, a central inbound item conveyor may also be used to feed the inbound item conveyors 84 of a plurality of item transfer stations 68.

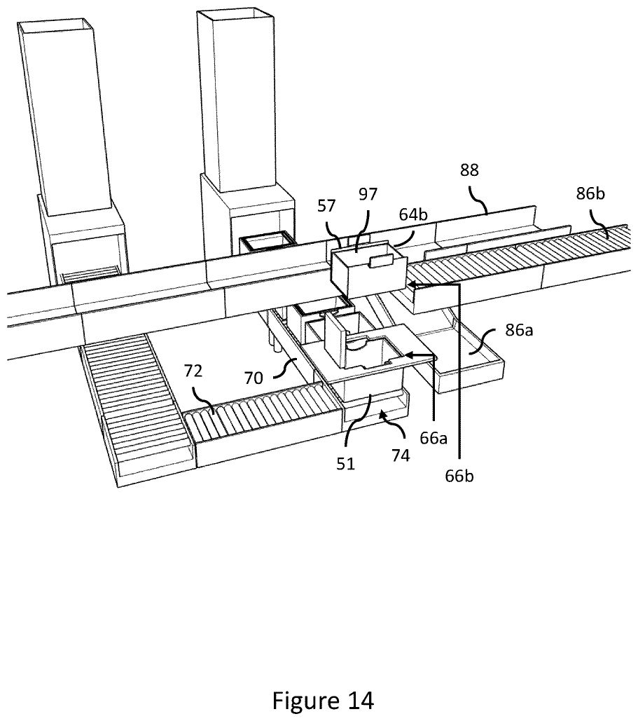

FIG. 14 shows a third example item transfer station 68 for removing two types of items from container units—trash and empty product sub-containers 97. The third transfer station 68 may be useful for emptying container units 50 before they are re-used within the system (e.g. re-filled with an item).

The lifting device 74 is configured to lift the insert 57 of a container unit 50 to a first raised position 66a or a second raised position 66b that is higher than the first raised position 66a, depending on the item transfer operation.

The third item transfer station 68 comprises a first outbound item conveyor 86a and a first item moving device 78a (not shown) associated with the first raised position 66a. The first outbound item conveyor 86a is configured to receive trash from one of the end openings 64b of the insert 57 and transport the trash away from the lifting device 74.

The third item transfer station 68 further comprises a second outbound item conveyor 86b and a second item moving device 78b (not shown) associated with the second raised position 66b. The second outbound item conveyor 86b is configured to receive empty product sub-containers 97 from one of the end openings 64b of the insert 57 and transport the empty product sub-containers 97 away from the lifting device 74.

To remove trash from a container unit 50, the insert 57 is lifted to the first raised position 66a and the first item moving device 78a pushes any items of trash off the insert base 58 onto the first outbound item conveyor 86a via one of the end openings 64b.

To remove an empty product sub-container 97 from a container unit 50, the insert 57 is lifted to the second raised position 66b where the second item moving device 78b pushes the empty product sub-container 97 off the insert base 58 onto the second outbound item conveyor 86b via one of the end openings 64b.

Lifting the insert 57 of a container unit 50 to the first raised position 66a to perform a trash-removing operation may be carried out by default if the container unit 50 does not contain an empty product sub-container.

After the insert 57 has been emptied, the insert 57 is lowered back into the storage container 51 and the now-empty container unit 50 can be transported to another area of the storage and retrieval system via an outbound container conveyor 72.

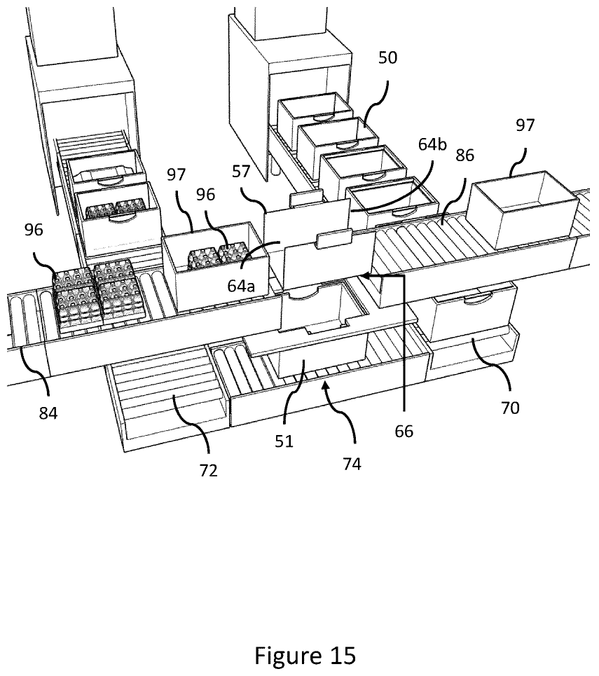

FIG. 15 shows a fourth example item transfer station 68 for loading products 96 and product sub-containers 97 into container units 50 and/or removing empty product sub-containers 97 from container units 50. The fourth item transfer station 68 allows container units 50 to be emptied and then loaded with new products 96 or product sub-containers 97 at the same item transfer station 68, rather than using separate item transfer stations 68 for emptying container units 50 and loading new products 96.

The fourth item transfer station 68 comprises an inbound item conveyor 84, an outbound item conveyor 86 and an item moving device 78 associated with the raised position 66 of the insert 57.

The inbound item conveyor 84 is configured to transport products 96 and product sub-containers 97 to a first end opening 64a of the insert channel 63. The outbound item conveyor 86 is configured to receive an empty product sub-container 97 from a second end opening 64b of the insert channel 63 and transport the empty product sub-container 97 away from the lifting device 74.

Once a container unit 50 has been received at the lifting device 74, the insert 57 is raised to the raised position 66. If the insert 57 contains an empty product sub-container 97, then the item moving device 78 pushes the empty product sub-container 97 off the insert base 58 onto the outbound item conveyor 86 via the second end opening 64b. The item moving device 78 then pushes a new product 96 or product sub-container 97 from the inbound item conveyor 78 onto the insert base 58 via the first end opening 64a. Depending on the design of the item moving device 78, these two item transferring operations may be performed substantially simultaneously.

After the insert 57 has been loaded with a new product 96 or product sub-container 97, the insert 57 is lowered back into the storage container 51 and the now-loaded container unit 50 can be transported to the storage area using the outbound container conveyor 72.

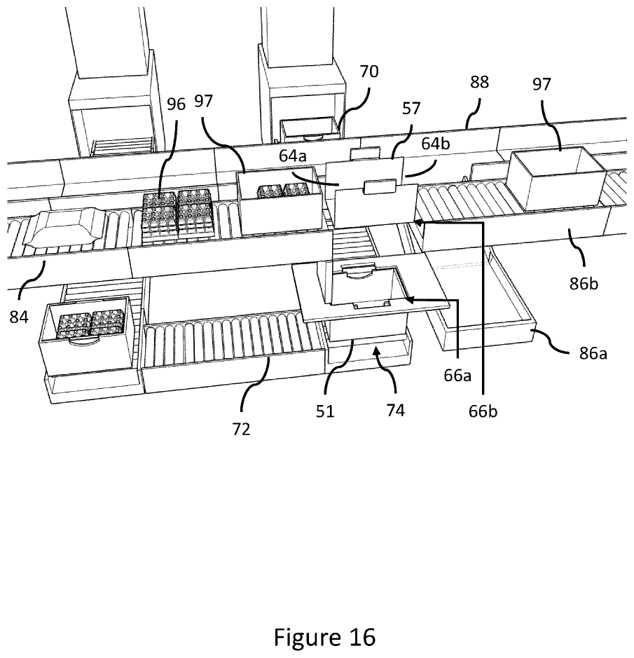

FIG. 16 shows a fifth example item transfer station 68 at which products 96 and/or product sub-containers 97 can be loaded into a container unit 50, and at which trash and/or empty product sub-containers 97 can removed from a container unit 50. The fifth item transfer station 68 allows container units 50 to be emptied and then loaded with new products 96 at the same item transfer station 68, rather than using separate item transfer stations 68 for emptying container units 50 and loading new products 96.

The fifth item transfer station 68 essentially corresponds to the third item transfer station 68 with the addition of an inbound item conveyor 84 associated with the second raised position 66b of the insert 57. The inbound item conveyor 84 is configured to transport products 96 and product sub-containers 97 to a first end opening 64a of the insert channel 63. The second item moving device 78b (not shown) is further configured to push products 96 or product sub-containers 97 from the inbound item conveyor 84 onto the insert base 58. The first and second outbound item conveyors 86a, 86b are configured to receive trash and empty product sub-containers 97 respectively from a second end opening 64b of the insert channel 63.

Container units 50 arriving at the lifting device 74 via the inbound container conveyor 70 may be empty, may contain trash, or may contain an empty product sub-container 97. Once a container unit 50 has been received at the lifting device 74, the insert 57 is raised to the first raised position 66a or the second raised position 66b, depending on the item transferring operation to be carried out.

If an empty container unit 50 arrives at the lifting device 74, then the insert 57 can be lifted to the second raised position 66b where the second item moving device 78 pushes a product 96 or product sub-container 97 from the inbound item conveyor 84 onto the insert base 58.

If a container unit 50 containing trash arrives at the lifting device, then the insert 57 can be lifted to the first raised position 66a where the first item moving device 78a pushes the trash off the insert base 58 onto the first outbound item conveyor 84a. The insert 57 can then be lifted to the second raised position 66b where the second item moving device 78b pushes a product 96 or product sub-container 97 from the inbound item conveyor 84 onto the insert base 58.

If a container unit 50 containing an empty product sub-container 97 arrives at the lifting device 74, then the insert 57 can be lifted to the second raised position 66b where the second item moving device 78b pushes the empty product sub-container 97 off the insert base 58 onto the second outbound item conveyor 86b. The second item moving device 78b can then push a new product 96 or product sub-container 97 from the inbound item conveyor 84 onto the insert base 58 (either at the same time, or after, pushing the empty product sub-container 97 off the insert base 58, depending on the design of the second item moving device 86b).

Lifting the insert 57 of a container unit 50 to the first raised position 66a to perform a trash-removing operation may be carried out by default if the container unit 50 does not contain an empty product sub-container.

After the item transferring operations are complete, the insert 57 is lowered back into the storage container 51 and the container unit 50 is transported away from the lifting device 74 by the outbound container conveyor 72 to the storage area.

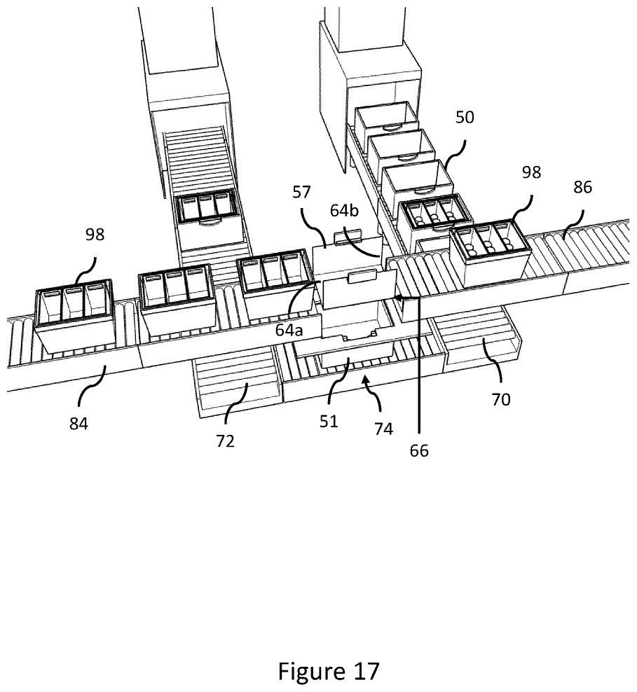

FIG. 17 shows a sixth item transfer station 68 at which delivery sub-containers 98 can be loaded into and/or removed from container units 50.

As mentioned above, delivery sub-containers 98 containing picked customer orders may be stored in container units 50 in the storage area until it is time for the delivery sub-containers 98 to be delivered to customers. In the storage and retrieval system, delivery sub-containers 98 are separated from storage containers 51 before they are loaded onto delivery vehicles and therefore the sixth item transfer station 68 operates to separate delivery sub-containers 98 from storage containers 51. The sixth item transfer station 68 also allows empty container units 50 to be filled/re-filled with an empty delivery sub-container 98 for receiving picked customer orders.

The sixth item transfer station 68 is configured essentially the same as fourth item transfer station 68 except that the inbound item conveyor 84 is now configured to transport empty delivery sub-containers 98 to the first end opening 64a of the insert channel 63 and the outbound item conveyor 84 is now configured to receive loaded delivery sub-containers from the second end opening 64b and transport them away from the lifting device 74.

If an empty container unit 50 arrives at the lifting device 74, the insert 57 is lifted to the raised position 66 and the item moving device 78 (not shown) pushes an empty delivery sub-container 98 off the inbound item conveyor 84 onto the insert base 58 via the first end opening 64a.

If a container unit 50 arrives at the lifting device 74 contains a loaded delivery sub-container 98, the insert 57 is lifted to the raised position 66 and the item moving device 78 pushes the delivery sub-container 98 off the insert base 58 onto the outbound item conveyor 86 via the second end opening 64b. The separated delivery sub-container 98 can then be transported to a vehicle loading area, for example. If the container unit 50 is to be reused to hold a new delivery container 98, the item moving device 78 pushes an empty delivery sub-container 98 off the inbound item conveyor 84 and onto the insert base 58 (which, as described above, can be done at the same time as pushing a delivery sub-container 98 off the insert base 58, depending on the design of the item moving device).

After the item transferring operations are complete, the insert 57 is lowered back into the storage container 51 and the container unit 50 is transported away from the lifting device 74 by the outbound container conveyor 72.

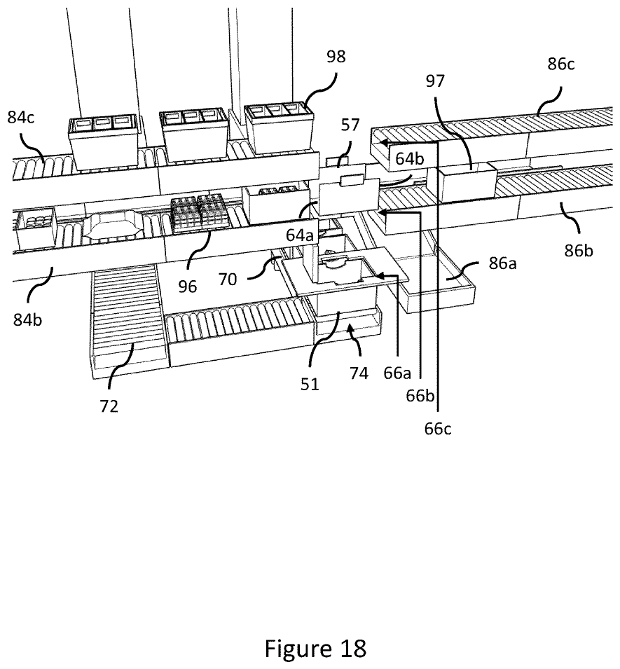

FIG. 18 shows a seventh item transfer station 68 at which multiple types of items can be loaded into and/or removed from container units 50. The seventh item transfer station 68 is configured to load products 96, loaded product sub-containers 97 and empty delivery sub-containers 98 into container units 50, and unload trash, empty product sub-containers 97 and loaded delivery sub-containers 98 from container units 50, using a single item transfer station 68.

The seventh item transfer station is essentially a combination of the first to sixth item transfer stations described above.

The lifting device 74 is configured to lift the insert 57 to any one of a first raised position 66a, a second raised position 66b that is higher than the first raised position 66a, and a third raised position 66c that is higher than the second raised position 66b, depending on the item transferring operations that are required.

The first raised position 66a is for removing trash. The seventh item transfer station 68 comprises a first outbound item conveyor 86a associated with the first raised position 66a for transporting trash away from lifting device 74 and a first item moving device 78a associated with the first raised position 66a configured to push trash out of the insert 57 onto the first outbound item conveyor 86a.

The second raised position 66b is for loading products 96 and loaded product sub-containers 97 and/or unloading empty product sub-containers. The seventh item transfer station 68 further comprises a second inbound item conveyor 84b (there is no “first” inbound item conveyor in this example), a second outbound item conveyor 86b and a second item moving device 78b (not shown) associated with the second raised position 66b. The second inbound item conveyor 84b is configured to transport products 96 and loaded product sub-containers 97 to a first end opening 64a of the insert channel 63; the second outbound item conveyor 74b is configured to receive empty product sub-containers 97 from a second end opening 64b of the insert channel 63 and transport them away from the lifting device 74; and the second item moving device 78b is configured to push products 96 and product sub-containers 97 off the second inbound item conveyor 84b onto the insert base 58 via the first end opening 64a, and push empty product sub-containers 97 off the insert base 58 onto the second outbound item conveyor 86b via the second end opening 64b.

The third raised position 66c is for loading and/or removing delivery sub-containers 98. The seventh item transfer station 68 further comprises a third inbound item conveyor 84c, a third outbound item conveyor 86c, a third item moving device 78c (not shown) associated with the third raised position 66c. The third inbound item conveyor 84c is for transporting empty delivery sub-containers 98 to the first end opening 64 of the insert base 58; the third outbound item conveyor 86c is for receiving loaded delivery sub-containers 98 from the second end opening 64b of the insert base 58 and transporting them away from the lifting device 74; and the third item moving device 78c is for pushing empty delivery sub-containers 97 off the third inbound item conveyor 84c onto the insert base 58 via the first end opening 64a, and pushing loaded delivery sub-containers 97 off the insert base 58 onto the third outbound item conveyor 86c via the second end opening 64b.

Container units 50 arriving at the lifting device 74 via the inbound container conveyor 70 may be empty or may contain: trash, empty product sub-containers 97 or loaded delivery sub-containers 98. Once a container unit 50 has arrived at the lifting device 74, the insert 57 is lifted one or more of the first to third raised positions 66a-66c depending on what type of items need to be transferred onto or off the insert 57. Once all the item transferring operations are complete, the insert 57 is lowered back into the storage container 51 and the container unit 50 is transported away from the lifting device 74 by the outbound container conveyor 72.

The seventh item transfer station 68 thus provides a multi-functional item transfer station 68 that may be useful for storage and retrieval systems with limited warehouse space.

Although all of the inbound item conveyors 84b, 84c of the seventh item transfer station 68 are shown as being on one side of the insert channel 63 and all of the outbound item conveyors 86a-86c are shown as being on the other side of the insert channel 63, this arrangement is not essential and each inbound and outbound item conveyor can be on any side, depending on the flow or items within the storage and retrieval system.

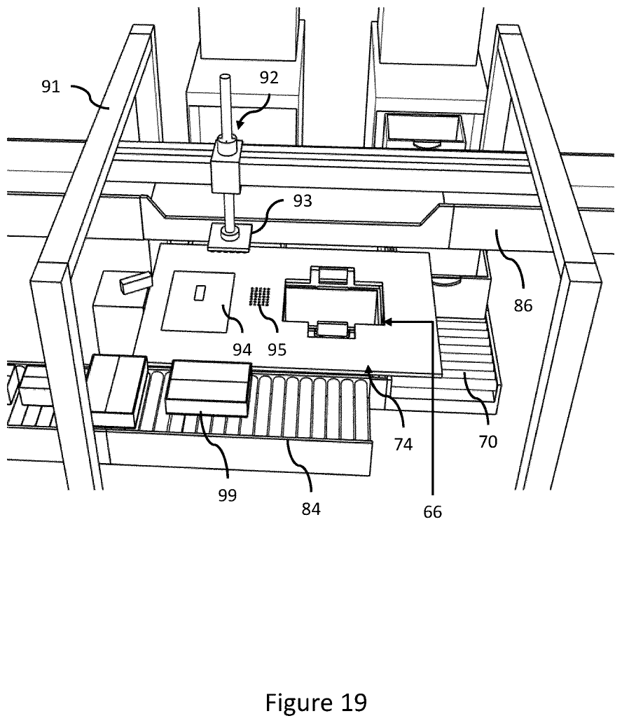

FIG. 19 shows an eighth item transfer station 68 at which products cased in cardboard can be automatically de-cased and loaded into container units. This eliminates the need for a separate area of the storage and retrieval system where cased products 99 are de-cased before being loaded onto an inbound item conveyor 84 for transportation to an item transfer station 68.

The eighth item transfer station 68 comprises a de-casing platform 90, an inbound item conveyor 84, and an outbound item conveyor 86 associated with the raised position 66 of the insert 57. The inbound item conveyor 84 is configured to transport cased products 99 to the de-casing platform 90 and the outbound item conveyor is configured to transport trash (removed cases) away from the de-casing platform.

The eighth item transfer station 68 further comprises an item moving device 78 in the form of a Cartesian robot 92 having a suction end effector 93 (though other types of robots, e.g. an articulated arm, and other end effectors for holding cased products 99 could also be used). The end effector 93 is mounted for movement on a gantry frame 91 extending over the de-casing platform 90 such that the end effector 93 can move along three orthogonal axes (two horizontal and one vertical). The end effector 93 is also preferably rotatable about a vertical axis to provide a fourth degree of freedom.

The de-casing platform 90 further comprises a cutting region 94 comprising one or more cutting blades protruding upwards from an upper surface of the de-casing platform 90, and a suction region 95 comprising one or more apertures extending through the de-casing platform 90 and a suction pump or other suction means for drawing air downwards through the apertures to generate a suction force.

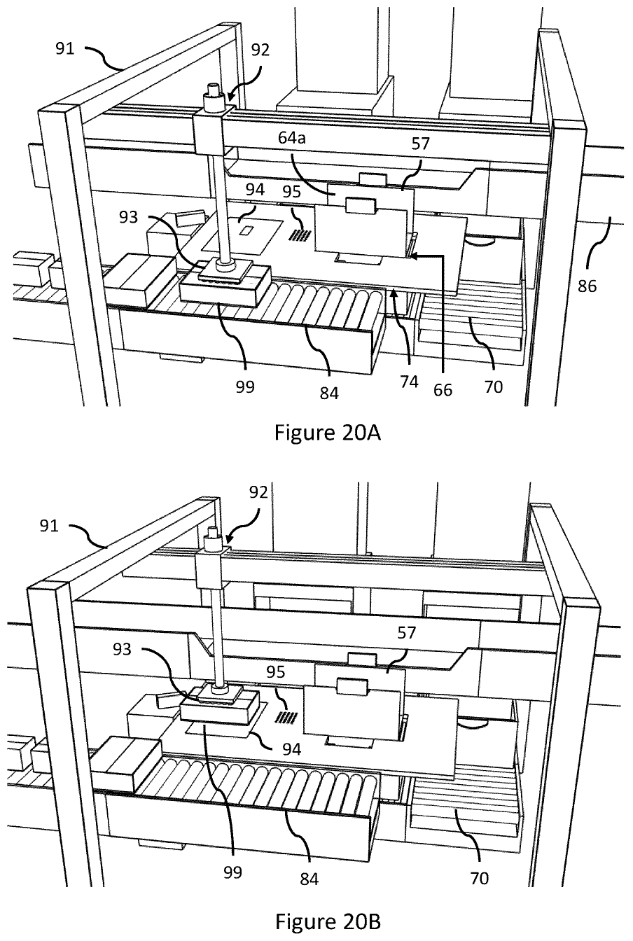

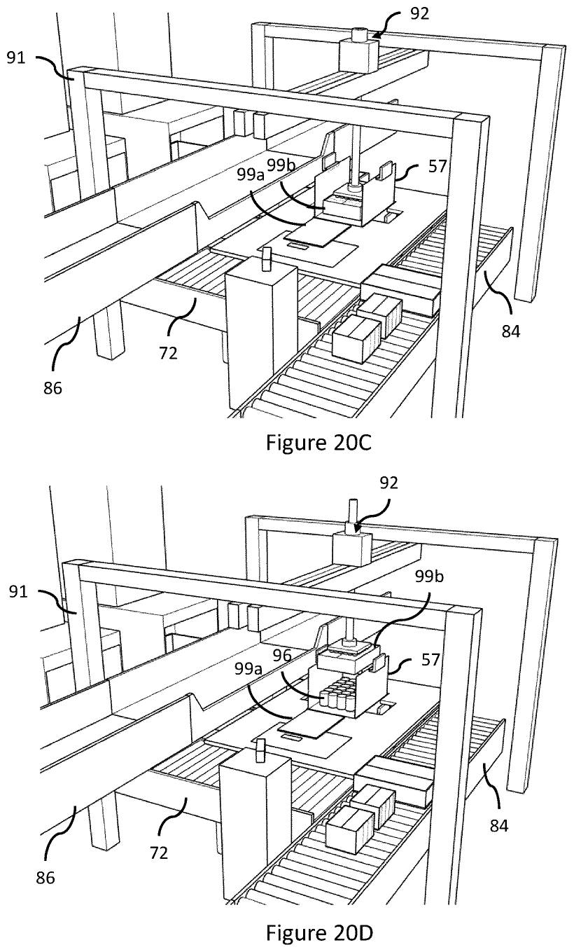

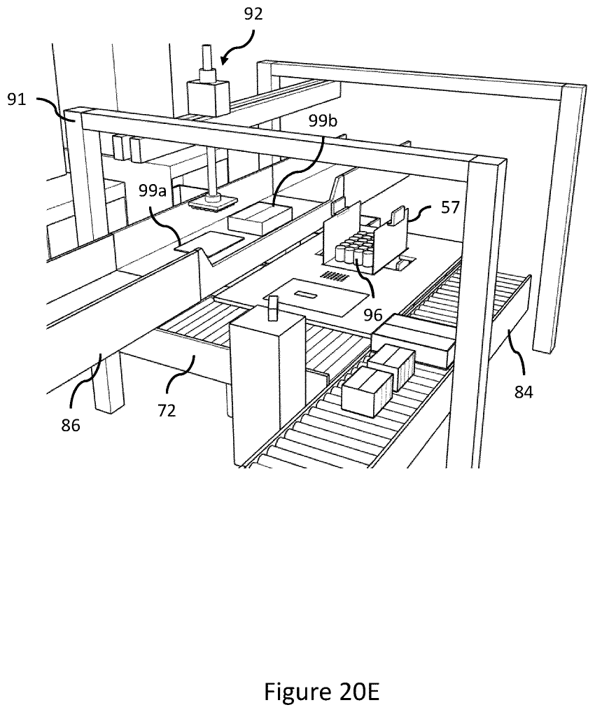

FIGS. 20A-20E are a sequence of drawings showing the eighth item transfer station 68 in use. Cased products 99 arrive at the de-casing platform 90 via the inbound item conveyor 84. The insert 57 of a container unit 50 at the lifting device 74 is lifted to the raised position 66. The Cartesian robot 92 picks up a cased product 99 from the inbound item conveyor 84 (FIG. 20A) and moves the cased product 99 (translationally and/or rotationally) relative to the cutting blade in the cutting region 94 such that the bottom portion 99a of the case of the cased product 99 is cut around the edge (FIG. 20B). The Cartesian robot 92 then slides the cased product 99 horizontally over the suction region 95 and into the insert channel 63 via one of the end openings 64a. As the cased product 99 slides over the suction region 95, the suction force holds the cut bottom portion 99a of the cased product 99 such that the product 96, now only encased on the sides and the top, slides directly onto the insert base 58 (FIG. 20C). The Cartesian robot 92 then raises the end effector 93 so that the remaining portion (top and sides) of the case 99b is lifted away from the product 96, leaving the product 96 on the insert base 58 (FIG. 20D). The Cartesian robot 92 can then drop the removed case 99b onto the outbound item conveyor 86 and pick up the bottom portion 99a of the case left on the suction region 95 and also drop it onto the outbound item conveyor 86 (FIG. 20E). Alternatively, for efficiency, a second end effector or another robot could be used to remove the bottom portion of the case 99a left on the suction region 95. The insert 57 is then lowered back into the storage container 51 and the container unit 50 is transported away from the lifting device 74 via the outbound container conveyor 72.

As an alternative to using an inbound item conveyor 84 to transport cased products 99 to the de-casing platform 90, the Cartesian robot 92 could instead pick up cased products 99 directly from pallets located next to the de-casing platform 90. The pallets may have been transported to the de-casing platform 90 by a forklift truck, for example.

From the above examples, it can therefore be seen that the container unit 50 and the item transfer station 68 of the present invention allows for an automated, flexible, multi-functional item transfer system in which one or more types of items can be transferred into and/or out of container units 50. Because items can be transferred into or out of the insert 57 by lifting the insert 57 and moving items in only a horizontal direction, there is no need to transfer items by picking them up, and therefore there is no need to take into account how different types of items (which may have different shapes, sizes, weights, compliabilities, fragilities etc.) need to be gripped and lifted in an automated system. There is therefore also no need to provide specialist equipment for picking each different type of item. The present invention therefore provides a system for transferring different types of items into and/or out of a storage container that is substantially agnostic to the type of item being transferred.

### Storage Structure and Load Handling Device

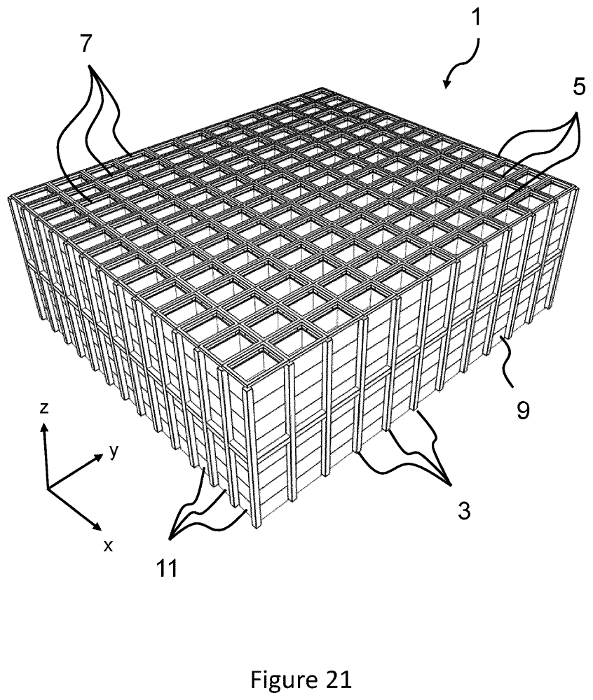

FIG. 21 illustrates an example storage structure 1 that may be used in the storage area of the storage and retrieval system to store the container units 50. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, container units 50 are arranged in stacks 11 beneath the grid cells 14 defined by the grid pattern, one stack 11 of container units 50 per grid cell 14.

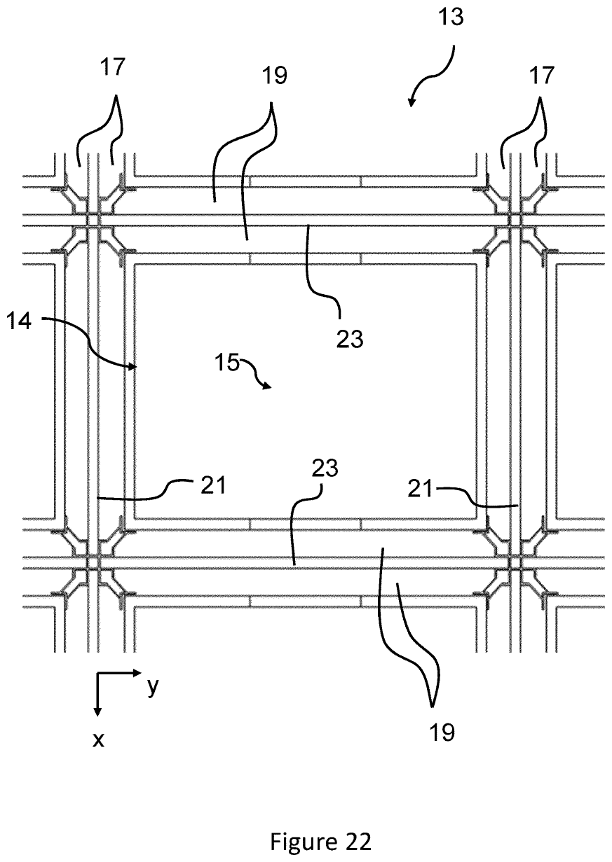

FIG. 22 shows a large-scale plan view of a section of track structure 13 forming part of the storage structure 1 illustrated in FIG. 21 and located on top of the horizontal members 5, 7 of the storage structure 1 illustrated in FIG. 21. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow container units 50 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

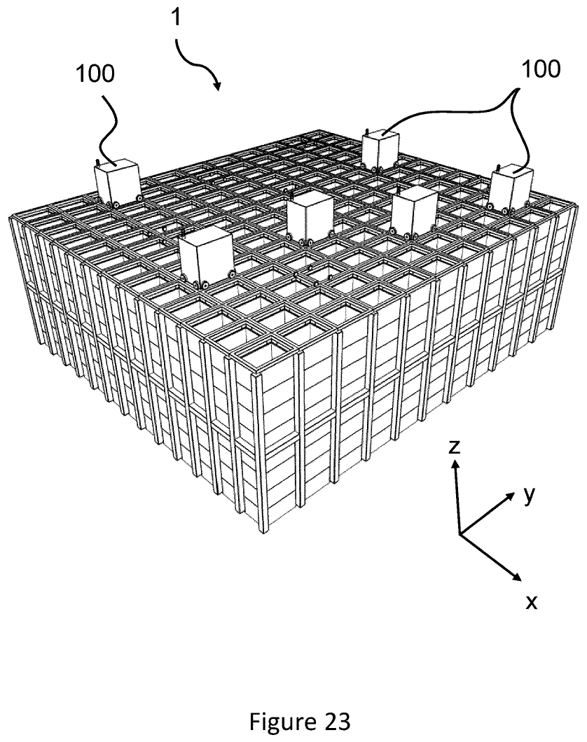

FIG. 23 shows a plurality of load handling devices 25 moving on top of the storage structure 1 illustrated in FIG. 21. The load handling devices 25, hereinafter referred to as “bots”, are provided with sets of wheels to engage with corresponding x- or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighbouring grid cells 14 without colliding with one another.

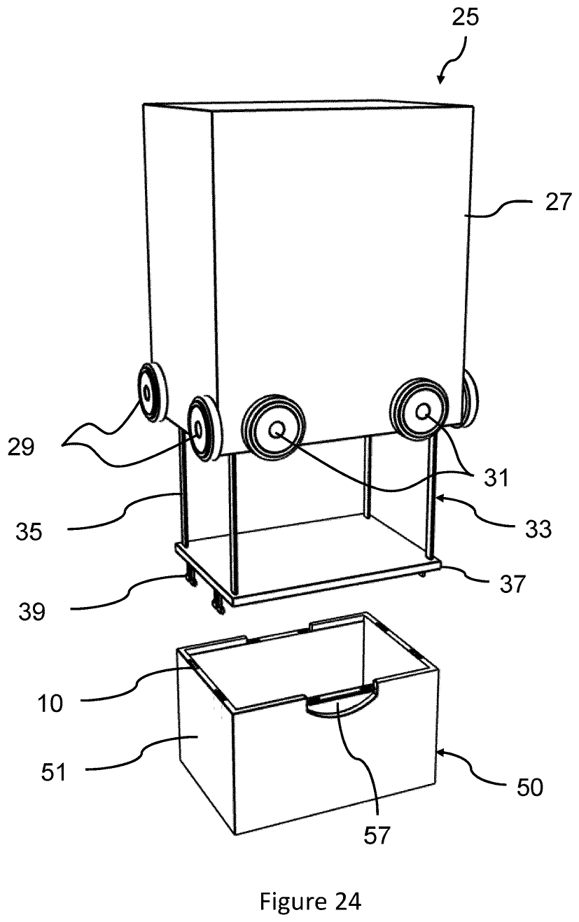

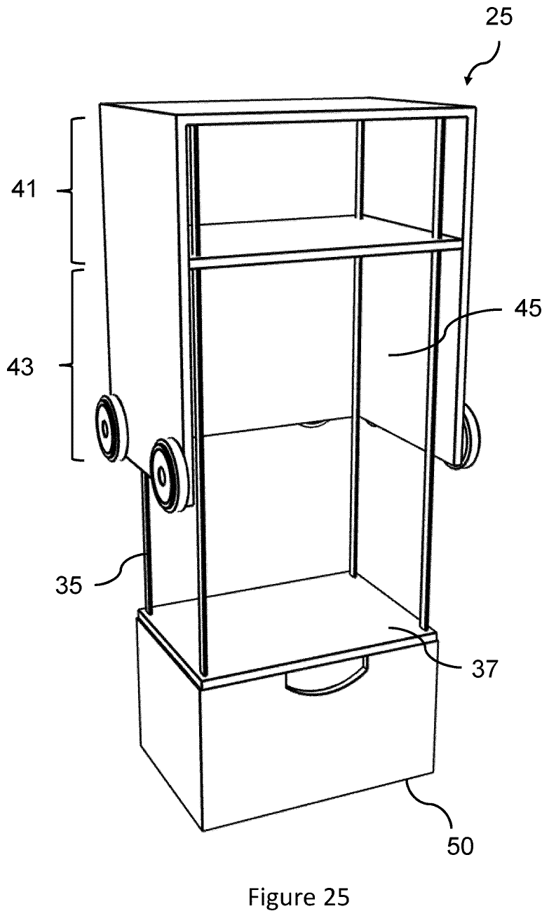

As illustrated in FIG. 24, a bot 25 comprises a body 27 in or on which are mounted one or more components which enable the bot 25 to perform its intended functions. These functions may include moving across the storage structure 1 on the track structure 13 and raising or lowering container units 50 (e.g. from or to stacks 11) so that the bot 25 can retrieve or deposit container units 50 in specific locations defined by the grid pattern.

The illustrated bot 25 comprises a driving assembly comprising first and second sets of wheels 29, 31 which are mounted on the body 27 of the bot 25 and enable the bot 25 to move in the x- and y-directions along the tracks 17 and 19, respectively. In particular, two wheels 29 are provided on the shorter side of the bot 25 visible in FIG. 24, and a further two wheels 29 are provided on the opposite shorter side of the bot 25. The wheels 29 engage with tracks 17 and are rotatably mounted on the body 27 of the bot 25 to allow the bot 25 to move along the tracks 17. Analogously, two wheels 31 are provided on the longer side of the bot 25 visible in FIG. 24, and a further two wheels 31 are provided on the opposite longer side of the bot 25. The wheels 31 engage with tracks 19 and are rotatably mounted on the body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the body 27, thereby enabling the load handling device 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 27 of the bot 25 stays substantially at the same height and therefore the weight of the body 27 and the components mounted thereon does not need to be lifted and lowered by the wheel-positioning mechanism.

The bot 25 also comprises a lifting mechanism 33 and a container-holding device 37 configured to raise and lower container units 50. The illustrated lifting mechanism 33 comprises four tethers 35 which are connected at their lower ends to the container-holding device 37. The tethers 35 may be in the form of cables, ropes, tapes, or any other form of tether with the necessary physical properties to lift the containers 9. The container-holding device 37 comprises a gripping mechanism 39 configured to engage with features of the storage containers 51 of the container units 50 to releasably hold the container units 50 from above. In the illustrated example, the gripping mechanism 39 comprises legs that can be received in corresponding apertures 10 in the rim of the storage container 51 of a container unit 50 and then moved outwards to engage with the underside of the rim of the storage container 51. The tethers 35 can be wound up or down to raise or lower the container-holding device 37 as required. One or more motors and winches or other means may be provided to effect or control the winding up or down of the tethers 35.

In FIG. 25, a side panel of the bot 25 has been omitted from view to allow the interior of the bot 25 to be seen. The body 27 of the illustrated bot 25 has an upper portion 41 and a lower portion 43. The upper portion 41 is configured to house or support one or more operation components (not shown), such as components of the lifting mechanism 33 (e.g. motors), wireless communication components, one or more processors for controlling operation of the bot 25, etc. The lower portion 43 is arranged beneath the upper portion 41. The lower portion 43 is externally open at the bottom and defines a container-receiving space 45 for accommodating at least part of a container unit 50 that has been raised into the container-receiving space 45 by the lifting mechanism 33. The container-receiving space 45 is sized such that enough of a container unit 50 can fit inside the space 45 to enable the bot 25 to move across the track structure 13 on top of storage structure 1 without the underside of the container unit 50 catching on the track structure 13 or another part of the storage structure 1. When the bot 25 has reached its intended destination, the lifting mechanism 33 controls the tethers 35 to lower the container-holding device 37 and the corresponding container unit 50 out of the space 45 and into the intended position. The intended position may be a stack 11 of container units 50 or an egress point of the storage structure 1 (or an ingress point of the storage structure 1 if the bot 25 has moved to collect a container unit for storage in the storage structure 1). Although in the illustrated example the upper and lower portions 41, 43 are separated by a physical divider, in other examples, the upper and lower portions 41, 43 may not be physically divided by a specific component or part of the body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the body 27 of the bot 25. For example, the container-receiving space 45 may instead be adjacent to the body 27 of the bot 25, e.g. in a cantilever arrangement with the weight of the body 27 of the bot 25 counterbalancing the weight of the container unit 50 to be lifted. In such embodiments, a frame or arms of the lifting mechanism 33 may protrude horizontally from the body 27 of the bot 25, and the tethers 35 may be arranged at respective locations on the protruding frame/arms and configured to be raised and lowered from those locations to raise and lower a container into the container-receiving space 45 adjacent to the body 27.

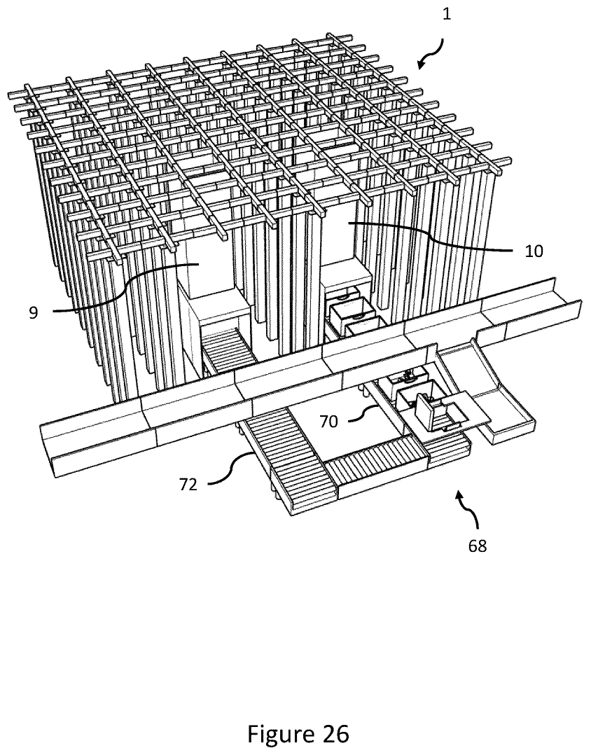

The storage structure 1 may interface with one or more of the item transfer stations 68 of the present invention via inbound and outbound container conveyors 70, 72. FIG. 26 shows an example in which storage structure 1 comprises an ingress column 9 and an egress column 1, each located under a respective grid cell. The inbound container conveyor 70 of the item transfer station 68 is arranged between the bottom of the egress column 10 and the lifting device 74 so that container units 50 dropped off by a bot 31 at the egress column 10 can be transported to the lifting device 74 via the inbound container conveyor 70. Similarly, the outbound container conveyor 72 of the item transfer station 68 is arranged between the bottom of the ingress column 9 and the lifting device 74 so that container units 50 leaving the lifting device 74 can be directly transported to the ingress column. Once the container unit 50 is at the bottom of the ingress column, it can be picked up by a bot 25 for entry into the storage structure 1. As an alternative to using a bot 25 to pick up and drop off container units 20 through the whole ingress column 9 and through the egress column 10, the ingress and egress columns 9, 10 may each comprise a container lift for raising and lowering container units 50 within the ingress and egress columns 9, 10. The container lift may lower container units 50 at least part of the way down the egress column 10 to the inbound container conveyor 70 and lift container units 50 at least part of the way up the ingress column 9 from the outbound container conveyor 72.

The storage and retrieval system may further comprise a central control system configured direct the movement of the bots 31 and the container units 50 within storage and retrieval system, and to keep track of the contents of each container unit 50. Each container unit 50, product sub-container 97 and delivery sub-container 98 may have a unique identifier (e.g. a barcode or an RFID tag) and the products 96 may classified into stock keeping units (SKUs) with unique identifiers (e.g. a barcode or RFID tag). By scanning the identifier of items and container units 50 when they enter and leave the storage and retrieval system and by keeping track (e.g. in a database) of where the container units 50 and items are transported to, the control system can direct particular container units 50 to particular item transfer stations 68 to carry out particular item transfer operations. Furthermore, for multi-functional item transfer stations 68 that use a plurality of raised positions 66 to transfer multiple types of items, the control system can direct the lifting device 74 to lift the insert to a particular raised position 66, and active a particular item moving device 78, depending on the existing contents or the intended contents of the container unit 50.

The invention is not limited to the precise forms described above and various modifications and variations will be apparent to the skilled person without departing from the scope of the invention as defined in the accompanying claims.

1. An item transfer system comprising:
a container unit including:
a storage container having a top opening; and
an insert configured to nest within the storage container, the insert including an insert base and a pair of opposing insert sidewalls extending upwardly from the insert base to define an insert channel having a pair of end openings opposing each other in a horizontal direction for allowing items to enter and exit the insert channel in a horizontal direction; and an item transfer station including:
a lifting device configured to vertically move the insert out of the storage container to a raised position at which the insert base is above the storage container and to vertically move the insert back into the storage container from the raised position; and
an item moving device configured to horizontally move an item onto and/or off the insert base via the end openings when the insert is in the raised position.

2. The item transfer system of claim 1, wherein the item transfer station is configured to engage the insert sidewalls to vertically move the insert into and out of the storage container.

3. The item transfer system of claim 2, wherein each of the insert sidewalls comprises:
a horizontally extending handle, and the lifting device is configured to engage the handles to vertically move the insert into and out of the storage container.

4. The item transfer system according to claim 3, wherein the handles of the insert extend outwardly, and the storage container comprises:
a pair of opposing container sidewalls, each container sidewall including a cutout extending downwardly from a top surface of the container sidewall, the cutouts being configured such that each handle protrudes into a space defined by each cutout when the insert is nested in the storage container.

5. The item transfer system according to claim 1, wherein the storage container comprises:
container sidewalls arranged to define two opposing side openings, and at least a portion of each insert sidewall is configured to occupy a respective side opening such that the insert sidewalls and the container sidewalls form a substantially contiguous structure.

6. The item transfer station according to claim 5, wherein the insert sidewalls are configured to interlock the container sidewalls in a vertical direction when the insert is nested within the storage container.

7. The item transfer system according to claim 1, wherein the item moving device comprises:
one or more pushing members configured to move in a direction parallel to a longitudinal axis running through the end openings of the insert channel to horizontally push an item onto and/or off the insert base via one of the end openings.

8. The item transfer system according to claim 1, wherein the item moving device comprises:
a first pushing member and a second pushing member spaced apart from the first pushing member in a direction parallel to a longitudinal axis of the insert channel, and the first and second pushing members are configured move in the direction parallel to the longitudinal axis of the insert channel to horizontally push a first item onto the insert base and horizontally push a second item off the insert base substantially simultaneously.

9. The item transfer system according to claim 1, wherein the item transfer station comprises:
an inbound item conveyor associated with the raised position of the insert, the inbound item conveyor being configured to transport items to the lifting device, and wherein the item moving device is configured to horizontally move an item off the inbound item conveyor for the item to be received onto the insert base via one of the end openings when the insert is in the raised position.

10. The item transfer system according to claim 9, comprising:
a central inbound item conveyor and a plurality of item transfer stations, each item transfer station including an inbound item conveyor, wherein the inbound item conveyors of the plurality of item transfer stations are configured to transport items from the central inbound item conveyor to the lifting device of their respective item transfer station.

11. The item transfer system according to claim 1, wherein the item transfer station comprises:
an outbound item conveyor associated with the raised position of the insert, the outbound item conveyor being configured to transport items away from the lifting device, and wherein the item moving device is configured to horizontally move an item off the insert base such that the item is received on the outbound item conveyor via one of the end openings when the insert is in the raised position.

12. The item transfer system according to claim 11, comprising:
a central outbound item conveyor and a plurality of item transfer stations, each item transfer station including an outbound item conveyor, wherein the outbound item conveyors of the plurality of item transfer stations are configured to transport items from the lifting device of their respective item transfer station to the central outbound item conveyor.

13. The item transfer system according to claim 1, wherein the item transfer station comprises:
an alignment mechanism configured to centrally align an item about a longitudinal axis running centrally through the end openings of the insert channel.

14. The item transfer system according to claim 1, wherein the lifting device is configured to vertically move the insert between the storage container and a plurality of raised positions, and the item transfer station comprises:
one or more item moving devices configured to horizontally move an item onto and/or off the insert base via the end openings at each raised position.

15. The item transfer system according to claim 14, wherein each raised position has an associated inbound item conveyor configured to transport items to the lifting device and/or an associated outbound item conveyor configured to transport items away from the lifting device, and for each raised position, the one or more item moving devices are configured to horizontally move an item off the associated inbound item conveyor such that the item is received on the insert base via one of the end openings, and/or the one or more item moving devices are configured to horizontally move an item off the insert base such that the item is received on the associated outbound item conveyor via one of the end openings.

16. The item transfer system according to claim 1, wherein the item transfer station comprises:
an inbound container conveyor configured to transport container units to the lifting device; and
an outbound container conveyor configured to transport container units away from the lifting device.

17. An item transfer system according to claim 1, in combination with a storage and retrieval system comprising:
the item transfer system;
a storage area in which a plurality of the container units are arranged in a plurality of vertical stacks; and
transporting means configured to transport container units from the storage area to the item transfer station and/or from the item transfer station to the storage area.

18. The storage and retrieval system of claim 17, wherein the storage area comprises:
a storage structure, the storage structure including a track structure mounted on top of a framework, the track structure including a first set of tracks and a second set of tracks, the first set of tracks extending in a first direction and the second set of tracks extending in a second direction, the second direction being substantially perpendicular to the first direction, to form a grid pattern defining a plurality of grid cells, wherein each stack of container units is arranged below a grid cell; and the storage and retrieval system includes one or more load handling devices, each load handling device including:
a driving assembly configured to horizontally move the load handling device on the track structure;
a container-holding device configured to releasably hold a container unit from above; and
a lifting mechanism configured to raise and lower the container-holding device.

19. The storage and retrieval system of claim 18, wherein the container-holding device comprises:
grippers and each storage container includes features configured to engage with the grippers to allow the container unit to be lifted by the container-holding device.
